(19) United States
(12) Patent Application Publication
(10) Pub. No.: US 2025/0193133 A1
(43) Pub. Date: Jun. 12, 2025

(54) AUTOMATED BOT SWITCHING ACCORDING TO DYNAMIC INTENT ANALYSIS

(71) Applicant: LIVEPERSON, INC., New York, NY (US)

(72) Inventors: Aman Kush, New York, NY (US); Ravi Gadekarla, New York, NY (US); Ravi Chittari, Cupertino, CA (US)

(73) Assignee: LIVEPERSON, INC., New York, NY (US)

(21) Appl. No.: 18/969,516

(22) Filed: Dec. 5, 2024

Related U.S. Application Data
(60) Provisional application No. 63/607,255, filed on Dec. 7, 2023.

(51) Int. Cl. H04L 51/02; G06F 40/35

(52) U.S. Cl. CPC H04L 51/02; G06F 40/35

(57) ABSTRACT

Disclosed embodiments provide a framework for dynamically processing messages exchanged through communications sessions in real-time using machine learning algorithms and artificial intelligence to identify user intents and to seamlessly integrate automated bots associated with these identified intents into these communications sessions. The messages are processed in real-time to detect a present intent and determine whether an automated bot engaged in the communications session is associated with the intent. If the automated bot is not associated with the intent, the system can automatically identify another automated bot within the bot group that is associated with the intent. When the communications session is transferred to the identified automated bot, any contextual information garnered through the communications session is automatically provided to the automated bot to prevent repetitious queries during the communications session.

### CROSS-REFERENCE TO RELATED APPLICATIONS

The present patent application claims the priority benefit of U.S. Provisional Patent Application No. 63/607,255, filed Dec. 7, 2023, the disclosures of which are incorporated by reference herein.

### FIELD

The present disclosure relates generally to systems and methods for automated transfers of communications sessions amongst different bots. More specifically, techniques are provided to deploy a framework for dynamically processing messages exchanged through communications sessions in real-time using machine learning algorithms and artificial intelligence to identify user intents and to seamlessly integrate the appropriate bots into these communications sessions.

### SUMMARY

Disclosed embodiments provide a system for dynamically processing messages exchanged through communications sessions in real-time using machine learning algorithms and artificial intelligence to identify user intents and to seamlessly integrate automated bots associated with these identified intents into these communications sessions. The messages are processed in real-time to detect a present intent and determine whether an automated bot engaged in the communications session is associated with the intent. If the automated bot is not associated with the intent, the system can automatically identify another automated bot within the bot group that is associated with the intent. When the communications session is transferred to the identified automated bot, any contextual information garnered through the communications session is automatically provided to the automated bot to prevent repetitious queries during the communications session.

According to some embodiments, a computer-implemented method is provided. The computer-implemented method comprises dynamically monitoring a communications session in real-time as communications are exchanged between a user and an automated bot. The automated bot is associated with a bot group including a set of automated bots. The computer-implemented method further comprises identifying an intent associated with the communications. The computer-implemented method further comprises determining that the automated bot is incapable of providing responses corresponding to the intent associated with the communications. The computer-implemented method further comprises training a machine learning algorithm in real-time to dynamically associate different automated bots with identified intents. The machine learning algorithm is trained using a dataset of sample communications sessions, known intents, and automated bot responses corresponding to the known intents. The computer-implemented method further comprises identifying an alternative automated bot capable of providing the responses corresponding to the intent. The alternative automated bot is identified using the intent and the communications as input to the machine learning algorithm. The computer-implemented method further comprises automatically transferring the communications session in real-time from the automated bot to the alternative automated bot. The computer-implemented method further comprises updating the machine learning algorithm according to feedback corresponding to new responses. The new responses are generated by the alternative automated bot.

In some embodiments, the computer-implemented method further comprises providing contextual information previously obtained through the communications exchanged between the user and the automated bot. The contextual information is provided to prevent the alternative automated bot from submitting a repeated query for the contextual information.

In some embodiments, the computer-implemented method further comprises identifying a new intent associated with the communications session. The new intent is not associated with any automated bot within the set of automated bots. The computer-implemented method further comprises transmitting a fallback message through the communications session.

In some embodiments, the computer-implemented method further comprises automatically detecting contextual information exchanged through the communications session. The computer-implemented method further comprises storing the contextual information. When the contextual information is stored, the contextual information is available to the set of automated bots.

In some embodiments, the intent is identified as a result of the intent having a highest threshold value compared to other possible intents associated with the communications.

In some embodiments, the computer-implemented method further comprises identifying a new intent associated with the communications session. The new intent is not associated with any automated bot within the set of automated bots. The computer-implemented method further comprises transferring the communications session from the alternative automated bot to a live agent.

In some embodiments, the computer-implemented method further comprises detecting a prohibited communication. The prohibited communication is detected according to one or more policies. The computer-implemented method further comprises automatically transmitting a response message. The response message is automatically transmitted without bot intervention.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a bot orchestrator dynamically transfers an ongoing communications session from a first bot to a second bot based on a determination of a user intent associated with the ongoing communication session in accordance with at least one embodiment;

FIG. 2 shows an illustrative example of an environment in which a bot orchestrator dynamically monitors communications exchanged in real-time between users and automated bots associated with a bot group to automatically transfer the communications amongst the automated bots based on detected intents in accordance with at least one embodiment;

FIG. 3 shows an illustrative example of an environment in which a bot switch algorithm automatically and in real-time processes communications exchanged between a user and one or more automated bots associated with a bot group to automatically transfer the communications to another bot within the bot group based on a detected intent in accordance with at least one embodiment;

FIGS. 4A-4C show an illustrative example of an environment in which a bot orchestrator dynamically transfers a communications session between a user and a first bot associated with a bot group to a second bot in response to detecting an intent associated with the second bot in accordance with at least one embodiment;

FIGS. 5A-5C show an illustrative example of an environment in which an automated bot engaged in a communications session with a user automatically transfers the communications session to another automated bot based on a detected intent in accordance with at least one embodiment;

FIG. 6 shows an illustrative example of a process for transferring a communications session from a first bot within a bot group to a second bot within the bot group based on a detected intent in accordance with at least one embodiment;

FIG. 7 shows an illustrative example of a process for transferring a communication session to another bot within a bot group upon detection of an intent associated with the other bot in accordance with at least one embodiment;

FIG. 8 shows an illustrative example of a process for obtaining contextual information associated with a transferred communications session to identify information previously shared by a user engaged in the communications session in accordance with at least one embodiment;

FIG. 9 shows an illustrative example of a process for performing one or more actions according to applicable policies and in response to detection of a prohibited communication exchanged during a communications session between a user and a bot in accordance with at least one embodiment; and

FIG. 10 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

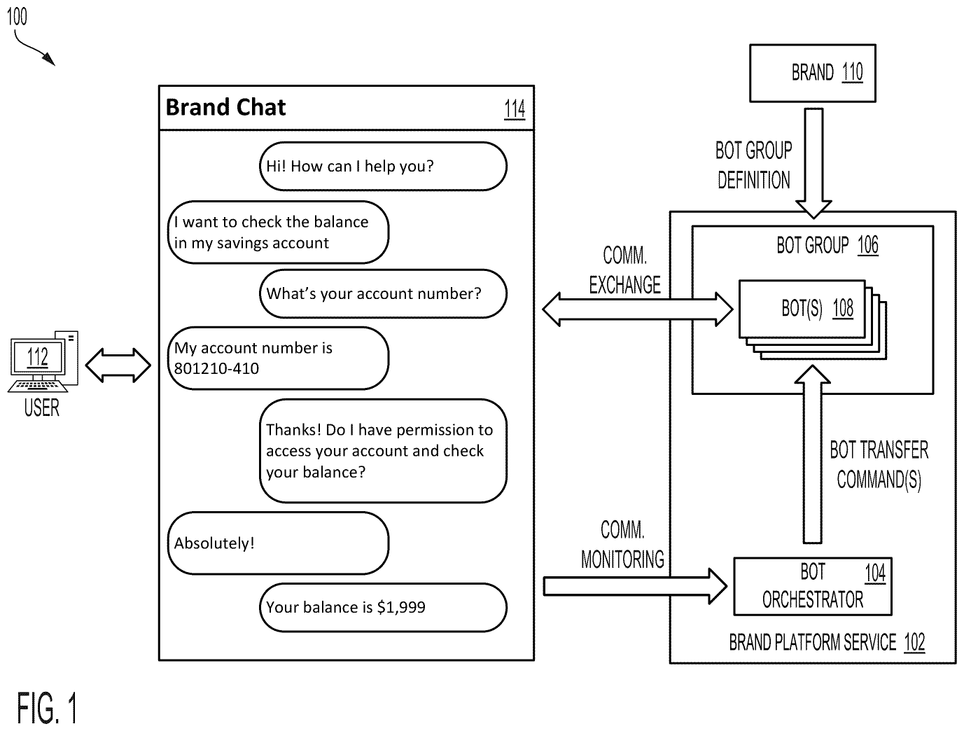

FIG. 1 shows an illustrative example of an environment 100 in which a bot orchestrator 104 dynamically transfers an ongoing communications session 114 from a first bot to a second bot based on a determination of a user intent associated with the ongoing communication session 114 in accordance with at least one embodiment. An intent may (for example) be a topic, sentiment, complexity, and/or level of urgency. A topic can include, but is not limited to, a subject, a product, a service, a technical issue, a use question, a complaint, a refund request or a purchase request, etc. In the environment 100, a brand platform service 102 facilitations a communications session 114 between a user 112 and different automated bots implemented by a brand 110 through the brand platform service 102. The brand platform service 102 may be an entity that provides, operates, or runs an online service for providing assistance to users associated with a brand 110 or other organization that provides services and/or goods to its users, such as user 112. For instance, the brand platform service 102 may provide user support on behalf of the brand 110 or other organization. In some embodiments, the brand platform service 102 is provided by the brand 110 or other organization to process requests and/or issues submitted by users associated with the brand 110.

In an embodiment, the brand platform service 102 allows brands, such as brand 110, to define bot groups including different sets of automated bots that may be configured to automatically communicate with users through ongoing communications sessions facilitated by the brand platform service 102. For example, as illustrated in FIG. 1, the brand 110 may define a bot group 106 that includes a set of automated bots 108 that are configured to automatically communicate with users for different intents and/or issues submitted by these users. A brand 110, through the brand platform service 102, may add automated bots to the bot group 106 to enable these automated bots to dynamically collaborate with one another during ongoing communications sessions with users in order to address user intents and/or issues associated with these users. For instance, the brand 110 may organize a set of automated bots 108 into a new bot group 106 that corresponds to a particular brand function (e.g., account management, billing, technical support, etc.). In some instances, the brand 110 may organize a set of automated bots 108 into a new bot group 106 according to the environment in which the set of automated bots 108 are configured to operate in (e.g., region-specific environment, linguistic environment, etc.). Through the designation of the set of automated bots 108 as being included in the bot group 106, the brand 110 may enable collaboration amongst the set of automated bots 108 for any communications session associated with the bot group 106.

An automated bot implemented by a brand 110 and added to a bot group 106 may be an automated process that is implemented or dynamically trained to communicate with users associated with the brand 110 in order to provide support or information to these users regarding an online service (e.g., information about products available at an online store) and/or to address any issues or requests submitted by a user 112 (e.g., requests for refunds, troubleshooting requests, etc.). The user 112, in some instances, can be an individual shopping an online store from a personal computing device, a brand 110 can be a company that sells products online (such as through an online marketplace), and the automated bot can be implemented by the brand 110, through the brand platform service 102, to communicate with the user 112 to provide information and/or support with regard to the products being sold online by the brand 110.

In some instances, an automated bot may be specialized to perform specific tasks. For example, for a bot group 106 defined to provide user support, a first automated bot within the bot group 106 may be configured or dynamically trained to initiate communications with a user through a communications session. The bot group 106 may further include different automated bots corresponding to different intents or user support dimensions. For instance, the bot group 106 may include an automated bot that is configured or trained to communicate with users with regard to active savings accounts. The bot group 106 may additionally, or alternatively, include an automated bot that is configured or trained to communicate with users with regard to account balance or transaction disputes. Thus, the automated bots within a bot group 106 may each be associated with different intents and/or issues for which the automated bot is configured or dynamically trained to address.

In an embodiment, the brand platform service 102 implements a bot orchestrator 104 that, for each ongoing communications session, dynamically processes communications exchanged between users and different automated bots associated with a bot group to determine whether to transfer the ongoing communications session from one automated bot to another automated bot within the bot group. The bot orchestrator 104 may be implemented on a computer system or other system (e.g., server, virtual machine instance, etc.) associated with the brand platform service 102. Alternatively, the bot orchestrator 104 may be implemented as an application or other executable process executed on one or more computer systems associated with the brand platform service 102. In some instances, the brand platform service 102 may implement a unique bot orchestrator 104 for each bot group 106 defined by the brand 110 and other brands associated with the brand platform service 102. For instance, when the brand 110 defines a new bot group 106 for a set of automated bots 108, the brand platform service 102 may instantiate a new bot orchestrator 104. This new bot orchestrator 104 may dynamically process any communications exchanged between users and any of the automated bots associated with this new bot group 106.

In an embodiment, the bot orchestrator 104 implements a machine learning algorithm or artificial intelligence that is dynamically trained in real-time to discover the patterns and/or intents associated with each automated bot added to a bot group 106. The machine learning algorithm or artificial intelligence may be dynamically trained in real-time using unsupervised training techniques. For instance, a dataset of sample communications sessions (e.g., historical communications sessions, hypothetical communications sessions, etc.) and corresponding automated bot responses (e.g., actual automated bot responses, hypothetical automated bot responses, etc.) may be analyzed using a clustering or classification algorithm to identify different patterns and/or intents that are associated with the different automated bots associated with the dataset. For instance, the machine learning algorithm or artificial intelligence may be dynamically trained in real-time by classifying communications between a sample user and an automated bot according to one or more vectors of similarity between the sample communications and other clusters of communications corresponding to different patterns and/or intents that may be associated with particular automated bots. Thus, through the machine learning algorithm or artificial intelligence, the bot orchestrator 104 may perform such clustering and obtain partial matches among other clusters of patterns and/or intents to identify the capabilities of each automated bot within a bot group 106. Example clustering algorithms that may be trained using this dataset may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. In some instances, the machine learning algorithm or artificial intelligence may be based on a Convolutional Neural Network (CNN) or other neural network that uses FastText embeddings and is trained to detect different intents from ongoing communications and associate these different intents with different automated bots according to interactions by these automated bots with users.

In an embodiment, the dataset used to dynamically train the machine learning algorithm or artificial intelligence is continuously updated in real-time as communications are exchanged between automated bots 108 associated with a bot group 106 and different users for different communications sessions. For instance, as the automated bots 108 within a bot group 106 communicate with users, the dataset of sample communications sessions may be updated to incorporate these new communications. As the dataset is updated, the clustering or classification algorithm may dynamically and in real-time analyze the dataset to detect any changes to previously identified patterns and/or intents corresponding to the automated bots 108. For example, as new communications between users and automated bots are received, the clustering or classification algorithm may perform re-clustering or re-classification of these communications according to a number of possible clusters or classifications. The dataset may be re-evaluated to re-classify the automated bots 108 according to the patterns and/or intents detected by the machine learning algorithm or artificial intelligence. Thus, over time and as new communications are exchanged between users and automated bots 108 within a bot group 106, the machine learning algorithm or artificial intelligence may be refined to better cluster or classify each automated bot as corresponding to particular patterns and/or intents.

In some instances, the machine learning algorithm or artificial intelligence may be dynamically retrained or reinforced according to feedback corresponding to automated bot communications during ongoing communications sessions. For instance, if a user expresses, during a communications session with a particular automated bot, that the automated bot is not providing relevant responses to the user's communicated intent or issue, the bot orchestrator 104 may determine that the automated bot is not associated with the communicated intent or issue. Accordingly, the bot orchestrator 104 may disassociate the automated bot from the originally assigned intent and perform a re-clustering or re-classification of the dataset of communications (including these newly exchanged communications) according to the number of possible clusters or classifications. Based on this re-clustering or re-classification, the automated bot may be assigned to a different intent.

In an embodiment, the bot orchestrator 104, through the aforementioned machine learning algorithm or artificial intelligence, can assign in real-time a threshold value to each automated bot 108 within a bot group 106 according to communications exchanged during a communications session 114. For example, for a detected intent, the bot orchestrator 104 may dynamically evaluate the communications associated with the intent and the known attributes of each automated bot 108 within the bot group 106 (e.g., known intents associated with each automated bot 108, known patterns associated with each automated bot 108, etc.) to assign a threshold value to each automated bot 108 according to the likelihood of the intent associated with automated bot being present within the communications. A higher threshold value may denote a greater confidence or likelihood that the corresponding automated bot associated with the particular intent may automatically address the intent or issue expressed by the user.

To determine the threshold value for each automated bot within the bot group 106, the bot orchestrator 104 may implement a Natural Language Understanding (NLU) engine that is dynamically trained to match or approximate a user's exchanged communication against a set of phrases, utterances, and/or knowledge base articles. For instance, in an embodiment, the bot orchestrator 104 dynamically converts set of phrases, utterances, and/or knowledge base articles corresponding to different intents into a set of known intent embeddings. The set of phrases and utterances may be obtained through historical data corresponding to previously conducted communications sessions. These previously conducted communications sessions may be annotated to indicate, for each communication or message included in these communications sessions, the corresponding intent. The bot orchestrator 104 may convert these communications or messages into different sets of embeddings that may be used to dynamically detect intents expressed through received communications or messages. The bot orchestrator 104 may be granted access to a significant number of internal and/or external data sources (e.g., private/organization-based data sources, publicly available data sources, etc.) such that the bot orchestrator 104 may maintain known intent embeddings derived from millions or billions of different data sources. Thus, the bot orchestrator 104, in some embodiments, is implemented using thousands, tens of thousands, or more processors that are configured to operate in parallel to process these data sources and generate corresponding intent embeddings.

The NLU engine, in an embodiment, is dynamically trained using a dataset comprising a large corpus of sample communications/messages (e.g., historical communications/messages, hypothetical communications/messages, combinations of historical and hypothetical communications/messages, etc.), sample embeddings corresponding to the sample communications/messages, and sample intents corresponding to the sample communications/messages. The NLU engine may be initialized with a first set of values corresponding to different hyperparameters or other coefficients that, in combination, are used to derive an output given a sample input (e.g., sample communications/messages). For instance, the bot orchestrator 104 may initialize a set of coefficients or other hyperparameters randomly according to a Gaussian distribution with low variance centered around zero. Using this initial iteration of the NLU engine, the bot orchestrator 104 may process the dataset of sample communications/messages to generate an output. This output may specify, for each sample communication or message, an intent corresponding to the sample communication or message. The NLU engine may compare the output (e.g., predicted intents) to the expected intents included in the dataset. Based on this comparison, the NLU engine may dynamically update the values corresponding to the different hyperparameters or other coefficients and again process the dataset to generate new outputs. This process may be repeated numerous times until an iteration of the NLU engine is obtained that satisfies one or more accuracy or predictability thresholds.

In an embodiment, the bot orchestrator 104 further determines whether the NLU engine is correctly converting the sample communications/messages into a set of embeddings and identifying appropriate intents according to this set of embeddings (e.g., correctly matching the set of embeddings to intent embeddings corresponding to different underlying intents, etc.). Based on this evaluation, the bot orchestrator 104 may dynamically update the NLU engine as described above to improve the accuracy of the NLU engine in identifying the intents expressed in communications or messages received through ongoing communications sessions.

Through the NLU engine, the bot orchestrator 104 may determine a confidence score or threshold value corresponding to the likelihood of a particular intent being present in the communication. Based on the confidence score or threshold value assigned to the communication, the bot orchestrator 104 may determine whether the communication may be transferred to the automated bot associated with the corresponding intent. For instance, if the confidence score or threshold value for a particular intent is below a pre-defined threshold, the bot orchestrator 104 may not transfer the communication to the automated bot associated with this particular intent. Alternatively, if the confidence score or threshold value for the particular intent exceeds the pre-defined threshold, the bot orchestrator 104 may transfer the communication to the automated bot associated with the particular intent to allow the automated bot to engage the user through the communications session 114.

To calculate a confidence score or threshold value corresponding to the likelihood of a particular intent being present in a particular communication/message, the aforementioned dataset of sample communications/messages, sample embeddings corresponding to the sample communications/messages, and sample intents corresponding to the sample communications/messages may be analyzed by the NLU engine to identify one or more entities from each data point. These identified entities may be designated with a tag corresponding to a predicted intent that may be associated with the data point (e.g., a sample communication or message). For each of these tags, the NLU engine may assign a confidence score, whereby a higher confidence score denotes a greater confidence or likelihood of the corresponding intent being associated with the sample communication or message. The determination of confidence scores may be tuned over time, as additional data points (e.g., intent classifications/tags and corresponding communications/messages) are obtained and used to train the NLU engine. For example, intents and corresponding confidence scores, as well as the original communication/message, may be evaluated to determine whether the NLU engine is accurately assigning intents to the elements included in the communication/message. For example, if the NLU engine assigns a high confidence score to an intent that has been assigned to a communication/message, and the intent does not actually correspond to the communication/message, the NLU engine may be retrained to reduce the likelihood (e.g., confidence score) for similar classifications of communications/messages.

In an embodiment, the bot orchestrator 104 evaluates the intents and corresponding confidence scores as provided by the NLU engine to determine which intent is to be associated with a communication/message. For example, as noted above, if the confidence score for a particular intent is below a pre-defined threshold, the bot orchestrator 104 may not transfer the communication to the automated bot associated with this particular intent. Alternatively, if any confidence scores corresponding to different intents exceed the pre-defined threshold, the bot orchestrator 104 may transfer the communication to the automated bot associated with the particular intent having the highest confidence score to allow the automated bot to engage the user through the communications session 114.

In an embodiment, the brand 110 can assign an automated bot to initiate communications with a user 112 when a communications session 114 is initially facilitated by the brand platform service 102. This automated bot may be configured or dynamically trained to automatically greet the user and prompt the user to indicate their intent or issue that they would like to have resolved. The automated bot may, in some instances, be associated with one or more patterns and/or intents such that the automated bot may serve the dual purpose of initiating the communications session with the user and addressing any issues corresponding to the assigned one or more patterns and/or intents. As an illustrative example, when the brand platform service 102 initiates a communications session 114 for the user 112, an automated bot from the bot group 106 designated to greet users may be activated in order to engage with the user 112. As illustrated in FIG. 1, this automated bot may transmit, through the communications session 114, the message “Hi! How can I help you?” This message may be used to prompt the user 112 to indicate what their intent or issue is that they wish to have resolved by the brand 110. Accordingly, subsequent communications exchanged by the user 112 may be analyzed in real-time to identify the intent or issue associated with these communications and to automatically transfer the communications session 114 to other automated bots 108 of the bot group 106 that are configured or dynamically trained to automatically resolve the intent or issue.

In an embodiment, as the user 112 communicates with an automated bot from the bot group 106 over the communications session 114, the bot orchestrator 104 may continuously, and in real-time, process these communications to detect any changes in the patterns and/or intents associated with the communications session 114. For instance, through the machine learning algorithm or artificial intelligence described above, the bot orchestrator 104 may continuously process the exchanged communications to identify any current patterns and/or intents associated with the communications session 114. Based on the identified patterns and/or intents, the bot orchestrator 104 may determine whether the current automated bot engaged with the user 112 through the communications session 114 is capable of addressing the identified intents or is otherwise associated with the identified patterns and/or intents.

If the bot orchestrator 104 determines that the current automated bot engaged with the user 112 through the communications session 114 is incapable of addressing the identified intents or is otherwise not associated with the identified patterns and/or intents, the bot orchestrator 104 may evaluate the other automated bots within the bot group 106 to determine whether another automated bot is associated with the identified patterns and/or intents. As noted above, through the machine learning algorithm or artificial intelligence and as the automated bots 108 associated with the bot group 106 engage with different users through different communications sessions, the bot orchestrator 104 may automatically identify any patterns and/or intents that are associated with each of the automated bots 108 within the bot group 106. The bot orchestrator 104 may accordingly associate these identified patterns and/or intents with the corresponding automated bots 108 within the bot group 106. When the bot orchestrator 104 detects one or more patterns and/or intents that are not associated with the current automated bot engaged with the user 112, the bot orchestrator 104 may automatically evaluate the other automated bots 108 within the bot group 106 to identify the automated bot that is associated with the one or more patterns and/or intents. Once identified, the bot orchestrator 104 may dynamically transfer the communications session 114 from the current automated bot to the identified automated bot.

In an embodiment, if the bot orchestrator 104 determines that the identified patterns and/or intents are not associated with any of the automated bots 108 within the bot group 106, the bot orchestrator 104 may transmit, over the communications session 114, a fallback message to the user 112. In some instances, the fallback message may indicate that the identified intent or other issue cannot be resolved through the communications session 114. The fallback message may further provide the user 112 with information for contacting a live agent associated with the brand 110 for resolution of their intent or other issue.

In an embodiment, if the bot orchestrator 104 determines that the identified patterns and/or intents are not associated with any of the automated bots 108 within the bot group 106, the bot orchestrator 104 may automatically transfer the communications session 114 to a live agent associated with the brand 110. The live agent may be a human agent that may be knowledgeable with regard to one or more intents or other issues that users may wish to have resolved. In some instances, the bot orchestrator 104 may automatically transfer the communications session 114 from an automated bot to a live agent based on different characteristics associated with the communications exchanged during the communications session 114 between the user 112 and the automated bots 108 associated with the bot group 106. For instance, the bot orchestrator 104, through the aforementioned machine learning algorithm or artificial intelligence, may generate a dynamic sentiment parameter that represents the user's sentiment (as expressed through their communications exchanged through the communications session 114). For example, if the dynamic sentiment parameter corresponds to an indication of user frustration with an automated bot, the bot orchestrator 104 may automatically switch the communications session 114 from the automated bot to a live agent. See U.S. Pat. No. 10,142,908, filed Jun. 2, 2016, the disclosure of which is incorporated by reference herein in its entirety for all purposes. In some instances, the communications session 114 may be monitored by a live agent associated with the brand 110. The live agent may intervene in the communications session 114 if they detect that the user 112 is becoming frustrated with an automated bot engaged in the communications session 114 or that the automated bot otherwise is incapable of resolving the user's intent or other issue and no other automated bot is available within the bot group 106 that is capable of addressing the intent or other issue.

It should be noted that, in some instances, a bot orchestrator 104 may not be required to facilitate automatic transfers of communications sessions amongst automated bots 108 within a bot group 106. For example, in an embodiment, an automated bot engaged in a communications session 114 with a user 112 implements the aforementioned machine learning algorithm or artificial intelligence to dynamically, and in real-time, determine the user's intent or other issue as communications are exchanged between the user 112 and the automated bot. If the automated bot, based on the detected intent or other issue, determines that it is incapable of automatically addressing this intent or other issue, the automated bot may determine whether a different automated bot within the bot group 106 is capable of addressing the detected intent or other issue. For instance, the automated bot may query the other automated bots 108 within the bot group 106 to determine whether any of these other automated bots 108 are capable of addressing the identified intent or other issue expressed by the user 112. If the automated bot identifies another automated bot within the bot group 106 that is capable of addressing the identified intent or other issue, the automated bot may automatically transfer the communications session 114 to this other automated bot.

In an environment in which the brand platform service 102 does not maintain a bot orchestrator 104 for the set of automated bots 108 within a bot group 106, the brand platform service 102 may implement, within the bot group 106, a standalone NLU engine that is dynamically trained to identify intents from ongoing communications sessions, associate these intents with the different automated bots 108 within the bot group 106, and to dynamically determine when automated transfers of communications sessions are to occur. The NLU engine may be dynamically trained, in real-time, using a dataset that includes sample intents and training phrases (e.g., historical phrases exchanged between actual users and automated bots, hypothetical phrases exchanged between hypothetical users and automated bots, etc.). This dataset may include, for each sample intent, a pre-defined number of sample training phrases that are known to be associated with the sample intent. These sample training phrases may be dynamically generated using generative artificial intelligence or other artificial intelligence methods. Alternatively, these sample training phrases may be obtained from historical communications sessions for which correlations between user phrases and intents are known.

As the NLU engine generates a taxonomy of intents through processing of the dataset, the taxonomy of intents may be analyzed (e.g., by the brand platform service 102, by the brand 110, etc.) to identify any intent overlaps that may impact performance of the NLU engine in detecting the appropriate intent for a given set of exchanged communications and, accordingly, selecting an automated bot that is capable of addressing the intent. If any overlaps are identified, the dataset may be modified to include sample intents and training phrases that are diverse (e.g., each sample intent and corresponding training phrases are distinguishable from other intents and other training phrases, etc.). Accordingly, through this training process, the NLU engine may automatically update the taxonomy of intents such that a corresponding intent domain includes a set number of intents that may be associated with different automated bots within the bot group 106. This process may reduce the likelihood of errors in detecting intents and transferring communications sessions to inappropriate automated bots that may be incapable of responding to the actual intent expressed in the exchanged communications. This reduction may further improve the processing of the automated bots and the underlying systems that implement these automated bots as these automated bots may be less prone to processing extraneous communications from users resulting from erroneous identification of intents (e.g., repetitions communications from users conveying their actual intent, repetitious communications from automated bots resulting from inabilities to process user communications, etc.).

In some instances, the NLU engine may be dynamically retrained, in real-time, as communications are exchanged between different users and different automated bots during ongoing communications sessions. For instance, when a communications session 114 is transferred to an automated bot within the bot group 106, subsequent communications between the automated bot and the user 112 may be evaluated in real-time and as these communications are exchanged to determine whether the automated bot is successful in addressing the underlying intent or other issue expressed by the user 112 and identified by the NLU engine. If the automated bot is unable to address the underlying intent or other issue expressed by the user 112, it may be an indication that the NLU engine has incorrectly associated the automated bot with the underlying intent or other issue. Additionally, or alternatively, this may serve as an indication that the taxonomy of intents generated by the NLU engine has resulted in overlaps that are causing confusion. Accordingly, based on this feedback, the NLU engine may be updated in order to reduce the likelihood of the automated bot being selected for the identified intent or other issue. Further, the taxonomy of intents may be updated in order to remove any identified overlaps or other issues that may result in confusion. The dataset used to dynamically train the NLU engine may be updated to incorporate this feedback such that, when the dataset is updated, a new version of the NLU engine is generated that incorporates the provided feedback. This process of updating the NLU engine may be performed continuously, in real-time or near real-time, as communications are exchanged amongst different users and different automated bots for different communications sessions and as feedback is received with regard to these different communications sessions.

In an embodiment, when a communications session 114 is transferred from an initial automated bot to a new automated bot based on an identified intent or other issue associated with the user 112, the new automated bot can automatically retrieve any contextual information associated with the communications session 114 and that was previously obtained from the user 112. For instance, as illustrated in FIG. 1, the user 112 has indicated that their account number is “801210-410.” In response to receiving this information, the bot orchestrator 104 may store this contextual information within a contextual state module that is implemented to persist any previously obtained information supplied by a user during an active communications sessions. The contextual state module may serve as a key-value datastore for such contextual information. For example, in response to the user communication “My account number is 801210-410,” the bot orchestrator 104, through the contextual state module, may generate a new key-value entry that indicates, for the field or “key,” that the corresponding value corresponds to the user's account number (e.g., the field or key is defined as “ACCOUNT NUMBER,” etc.). The key-value entry may further indicate the supplied account number such that the complete key-value entry may take the form of “ACCOUNT NUMBER=801210-410” or other similar form.

In an embodiment, the contextual state module implements a Natural Language Processing (NLP) algorithm or other machine learning algorithm/artificial intelligence that is dynamically trained to process, in real-time, communications exchanged between users and automated bots as these communications are exchanged to extract any contextual information provided by these users. The NLP algorithm may be dynamically trained using a dataset of sample communications (e.g., historical communications between actual users and automated bots, hypothetical or artificial communications between hypothetical users and automated bots, etc.) and known contextual information included in these communications. Further, the dataset may include expected key-value pairs corresponding to contextual information that should be extracted from the sample communications. This may allow for evaluation of the NLP algorithm to determine whether the NLP algorithm is correctly extracting the contextual information from the supplied sample communications and dynamically generating the correct key-value pairs corresponding to the extracted contextual information. If there are any errors detected in the identification of contextual information and/or in generating the corresponding key-value pairs, the NLP algorithm may be retrained to improve the likelihood of the NLP algorithm correctly identifying the contextual information and generating accurate key-value pairs corresponding to this contextual information.

In an embodiment, the NLP algorithm is further updated as communications are exchanged between users and different automated bots through different ongoing communications sessions. Using the illustrative example provided in FIG. 1, whereby the user 112 is prompted by an automated bot to provide their account number and the user 112 indicates that their account number is “801210-410,” the contextual state module may determine whether the NLP algorithm correctly identified this account number and recorded this account number within the key-value datastore for the communications session 114. If the contextual state module determines that a key-value entry for this account number has not been recorded, the contextual state module may determine that the NLP algorithm has failed to detect and record this contextual information. As another illustrative example, if the communications session 114 is transferred to another automated bot within the bot group 106, and the other automated bot prompts the user 112 to again provide their account number, the contextual state module may determine whether the contextual information was originally recorded when initially provided by the user. If the contextual information was recorded within the key-value datastore, the contextual state module may further determine whether the correct key (e.g., “ACCOUNT NUMBER”) was generated for the entry. In an embodiment, if the NLP algorithm correctly stored the contextual information provided by the user 112, but a subsequent automated bot prompts the user 112 to provide this contextual information, the contextual state module may determine that the issue resides with the automated bot's configuration. Accordingly, the contextual state module may notify the brand 110 of the issue so that the brand 110 may update the configuration of the automated bot in order to allow the automated bot to better recognize and obtain the previously supplied contextual information.

Feedback corresponding to the automatic identification of contextual information (or lack thereof) may be used to dynamically update the NLP algorithm. Returning to the earlier example where the user 112 is repeatedly prompted for their account number, the contextual state module may use these repeated prompts as feedback indicating that the provided contextual information was not detected and/or not properly recorded within the key-value datastore. Accordingly, the communications submitted by the user 112 with the requested contextual information may be annotated (such as by the contextual state module, the brand 110, the brand platform service 102, etc.) to indicate the expected key-value entry that should have been generated in response to these communications. This annotated datapoint may be added to the dataset used to train the NLP algorithm. This may allow for continued training of the NLP algorithm as new communications including contextual information are exchanged between users and automated bots.

As noted above, when a communications session 114 is transferred to another automated bot, the other automated bot may access the contextual state module to retrieve any previously provided contextual information associated with the communications session 114. The automated bot may be configured to evaluate this previously provided contextual information to determine whether this previously provided contextual information may be used for any of the routines executed by the automated bot. For instance, if the user 112 previously provided their account number and the automated bot requires this account number to identify the user's previous transactions, the automated bot may automatically use this previously provided account number in order to retrieve and provide the user 112 with an indication of their previous transactions without having to prompt the user 112 again to provide their account number. As another illustrative example, if the user 112 is prompted to provide their address in order to verify their identity, and the communications session 114 is transferred to another automated bot that requires this address to facilitate delivery of an item previously ordered by the user 112, the other automated bot may automatically evaluate the retrieved contextual information from the contextual state module to determine the user's address without requiring the other automated bot to prompt the user 112 to again provide their address.

In some instances, a brand 110 or other entity generating the bot group 106 and provisioning the automated bots 108 included in the bot group 106 may define the different types of contextual information that may be garnered by the automated bots 108 and used to support the myriad functions performed by these automated bots 108. For example, a brand 110 may configure the namespace for each variable corresponding to different pieces of contextual information that may be obtained from users. Further, the brand 110 may configure the automated bots to dynamically record obtained contextual information according to the configured namespaces. This may obviate the need to dynamically generate new keys for key-value pairs corresponding to particular information that may not be used by any of the automated bots 108 within a bot group 106.

When a communications session 114 is transferred to a new automated bot, the new automated bot may transmit an application programming interface (API) call to the contextual state module to retrieve the required contextual information from the key-value datastore. The API call may include a GET command that indicates the name of the namespace (e.g., the type of contextual information being requested) and any properties that may be used to identify the appropriate key-value pair that includes the required contextual information. The properties may include unique information associated with the user 112 and/or the communications session 114 (e.g., username, unique identifier for the communications session 114, timestamp corresponding to the time at which the communications session 114 was initiated, etc.). In response to the API call, the contextual state module may query the various key-value entries to identify any entries that satisfy the elements of the request. Accordingly, the contextual state module may return the requested contextual information to the automated bot.

If the requested contextual information is not available, the automated bot may prompt the user 112 for the contextual information. For instance, if the automated bot requires the user's account number in order to provide a response to the user's query for their account balance, and the contextual state module does not maintain a key-value entry corresponding to the user's account number, the automated bot (through the communications session 114) may prompt the user 112 to provide their account number. If the user 112 provides their account number in response to the request, the automated bot may automatically define a key-value pair that includes the provided account number in association with a namespace corresponding to account numbers (e.g., “ACCOUNT NUMBER,” etc.). For instance, through an API call to the contextual state module, the automated bot may indicate the namespace for the contextual information (e.g., “ACCOUNT NUMBER,” etc.), a property that may uniquely associate the key-value pair with the user 112 (e.g., username, communications session identifier, timestamp corresponding to the communications session 114, etc.), and the corresponding value (e.g., “801210-410,” any other account number information provided by the user 112, etc.).

The contextual information maintained by the contextual state module may be subject to an expiration or “time to live” whereby after the expiration or “time to live” has passed, the contextual information is automatically deleted. The expiration or “time to live” may apply to the key-value pairs and not to the keys (e.g., namespaces) themselves. The expiration or “time to live” for values corresponding to a particular key or namespace may be pre-defined by the brand platform service 102 by default. Alternatively, the expiration or “time to live” may be defined by the brand 110 when implementing a bot group 106 and the corresponding automated bots 108. The expiration of “time to live” for any key-value pair may exceed the amount of time related to any given communications session 114. For example, the expiration or “time to live” for values corresponding to a particular namespace may be defined using longer timescales (e.g., hours, days, weeks, months, etc.) such that these values may persist and remain available for future communications sessions associated with the same user 112. This may reduce the number of prompts that are provided to the user 112 through a communications session 114.

In an embodiment, the brand 110 and/or the brand platform service 102 can define a set of policies that may be applied to communications sessions between users and automated bots 108 within a bot group 106. These policies, when applied to communications sessions, may cause the brand platform service 102 to automatically intervene in these communications sessions without further need for automated bot interaction. For example, the brand 110 and/or the brand platform service 102 may implement a policy that prohibits the use of profanity within active communications sessions 114. This policy may provide executable instructions that may be executed when profanity is detected within an active communications session 114. As noted above, the bot orchestrator 104 may automatically process communications exchanged during an active communications session 114 to determine the intent or other issue being expressed through these communications and, accordingly, determine whether the communications session 114 should be transferred to another automated bot within the bot group 106. If the bot orchestrator 104 detects, from these communications, the use of profanity in violation of an applicable policy associated with the communications session 114, the bot orchestrator 104 may automatically execute the executable instructions included in the policy to address this violation of the applicable policy. For instance, the bot orchestrator 104 may automatically transmit a notification to the user 112 through the communications session 114 to cease the use of profanity during the communications session 114. As another example, the bot orchestrator 104 may mute or otherwise restrict the user's ability to exchange communications through the communications session 114 for a pre-defined period of time (e.g., one minute, five minutes, etc.). In some instances, the bot orchestrator 104 may automatically terminate the communications session 114.

In an embodiment, once the communications session 114 has concluded, the communications exchanged during the communications session 114 can be evaluated to obtain any feedback that may be used to update the machine learning algorithm or artificial intelligence implemented by the bot orchestrator 104 and/or the NLU engine implemented to identify intents from ongoing communications sessions, associate automated bots 108 to different patterns and/or intents, and to dynamically transfer the ongoing communications sessions to different automated bots according to these different patterns and/or intents. For instance, if the bot orchestrator 104 erroneously assigned a particular intent to an automated bot such that the automated bot was unable to address the particular intent during the communications session (e.g., the automated bot exchanged communications unrelated to the particular intent, the automated bot defaulted to a fallback message as a result of being unable to address the particular intent, the user communicated frustration or other sentiment indicative of the automated bot's inability to address the intent, etc.), the brand platform service 102 may evaluate the communications exchanged during the communications session to determine the appropriate intent communicated by the user and the appropriate automated bot (if any) to which the communications session should have been transferred to in order to address the user's intent. Through this evaluation, the brand platform service 102 may annotate these communications and add these annotated communications to the datasets used to dynamically train the machine learning algorithm or artificial intelligence implemented by the bot orchestrator 104 and/or the NLU engine.

It should be noted that the machine learning algorithm or artificial intelligence implemented by the bot orchestrator 104 and the NLU engine are continuously updated in real-time as communications are exchanged via different ongoing communications sessions. For instance, any feedback or other annotations made to communications exchanged during a particular communications session may be used to dynamically retrain the machine learning algorithm or artificial intelligence implemented by the bot orchestrator 104 and the NLU engine while the machine learning algorithm or artificial intelligence and the NLU engine continuously, and simultaneously, process communications associated with other ongoing communications sessions. This allows for the machine learning algorithm or artificial intelligence implemented by the bot orchestrator 104 and the NLU engine to be constantly updated in real-time based on feedback corresponding to these communications sessions and as the corresponding communications are exchanged.

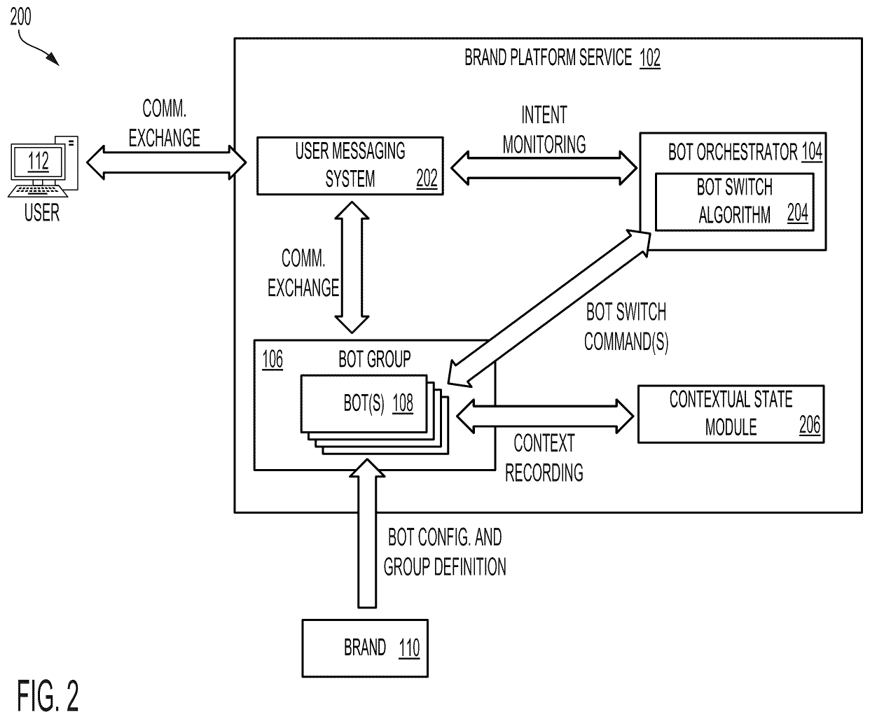

FIG. 2 shows an illustrative example of an environment 200 in which a bot orchestrator 104 dynamically monitors communications exchanged in real-time between users 112 and automated bots 108 associated with a bot group 106 to automatically transfer the communications amongst the automated bots 108 based on detected intents in accordance with at least one embodiment. In the environment 200, the brand platform service 102 implements a user messaging system 202 that facilitates communications sessions between users associated with the brand platform service 102 and different automated bots implemented by a brand 110 for different purposes. The user messaging system 202 may be implemented on a computing system of the brand platform service 102 or as an application executed by a computing system of the brand platform service 102.

As noted above, the brand 110 may organize different sets of automated bots 108 into a different bot groups 106 that correspond to particular brand functions and/or to the environments in which the different sets of automated bots 108 are configured to operate in. Through the designation of a set of automated bots 108 as being included in the bot group 106, the brand 110 may enable collaboration amongst the set of automated bots 108 for any communications session associated with the bot group 106. In an embodiment, when the user 112 accesses the user messaging system 202, the brand platform service 102 may prompt the user 112 to indicate the purpose for which they wish to communicate with the brand 110. For instance, the brand platform service 102, through the user messaging system 202, may provide the user 112 with various options corresponding to the different brand functions and/or environments within which the brand 110 operates. Further, these options may correspond to different bot groups 106 as defined by the brand 110. Accordingly, based on the user's selection of a particular option, the brand platform service 102, through the user messaging system 202, may facilitate a new communications session between the user 112 and the bot group 106 corresponding to the particular option.

In some instances, the user messaging system 202 may be implemented through a website or application implemented by the brand platform service 102 on behalf of the brand 110. Through this website or application, the brand platform service 102 may provide the user 112 with an option to request a new communications session in order to address a particular intent or issue. For example, through a graphical user interface (GUI) provided through the website or application, the brand platform service 102 may provide the user 112 with an option to initiate a new communications session and with the aforementioned options corresponding to the different brand functions and/or environments within which the brand 110 operates. Based on the user's selections, the brand platform service 102, through the user messaging system 202, may update the GUI to present the new communications session.

In an embodiment, when the brand platform service 102, through the user messaging system 202, facilitates a communications session between the user 112 and a particular bot group 106 according to the option selected by the user 112, an automated bot from the bot group 106 may engage the user 112 to allow for determination of the user's intent or other issue that the user 112 would like to have resolved. This first automated bot may be selected according to a configuration of the bot group 106 and the corresponding automated bots 108 as defined by the brand 110 through the brand platform service 102. For instance, a brand 110 may configure an automated bot that is programmed to automatically greet users when communications sessions are initiated with these users and to prompt these users to indicate their intents or other issues. As an illustrative example, this first automated bot may transmit the communication “Hi, what can I help you with?” once a new communications session has been established between a user 112 and the bot group 106. This communication may guide the user 112 to communicate their intent or other issue that they wish to have resolved. In some instances, each automated bot within the bot group 106 is configured to prompt the user 112 for their intent or other issue if the automated bot is selected to initiate communications with the user 112 through the communications session. This may allow for random selection of an automated bot from the bot group 106 to initiate communications with the user 112.

In an embodiment, as the user 112 communicates with one or more automated bots 108 associated with the bot group 106 through the user messaging system 202, the bot orchestrator 104 automatically, and in real-time, processes the myriad communications between the user 112 and these one or more automated bots 108 as these communications are exchanged to identify any patterns associated with these communications and the current intent associated with these communications. As noted above, the bot orchestrator 104 may be implemented to dynamically process, for each ongoing communications session, communications exchanged between users and different automated bots associated with a bot group to determine whether to transfer the ongoing communications session from one automated bot to another automated bot within the bot group. In some instances, a unique bot orchestrator 104 may be implemented for each bot group 106 such that the bot orchestrator 104 may only process communications associated with ongoing communications sessions including automated bots 108 from the designated bot group 106. In such instances, when a brand 110 provisions a new bot group 106 for a particular function or environment, the brand platform service 102 may provision a new bot orchestrator 104 for this new bot group 106.

In an embodiment, the bot orchestrator 104 implements a bot switch algorithm 204 that is dynamically trained in real-time to discover patterns and/or intents from ongoing communications sessions based on communications exchanged between users and automated bots. The bot switch algorithm 204 may be further dynamically trained in real-time to associate different intents with different automated bots within a bot group based on the communications exchanged between users and these different automated bots. The bot switch algorithm 204, in an embodiment, is a classification algorithm that is dynamically trained in real-time using unsupervised training techniques. For instance, the bot switch algorithm 204 may be trained using a dataset of sample communications sessions, corresponding automated bot responses, and known intents and patterns associated with the communications included in these sample communications sessions. The bot switch algorithm 204 may process this dataset to identify any patterns and/or intents associated with the sample communications sessions and classify the automated bots associated with these sample communications sessions according to the identified patterns and/or intents. These classifications may be evaluated to determine the accuracy of the bot switch algorithm 204 in identifying the correct patterns and/or intents and in assigning these patterns and/or intents to the sample automated bots associated with the sample communications sessions. Through this training process, the bot switch algorithm 204 may be implemented by the bot orchestrator 104 to dynamically process communications exchanged during ongoing communications sessions to detect any patterns and/or intents associated with these communications and accordingly determine which automated bots are associated with these patterns and/or intents. As noted above, the bot switch algorithm 204 may be implemented using FCM algorithms, EM algorithms, hierarchical clustering algorithms, DBSCAN algorithms, and the like. The bot switch algorithm 204 may alternatively be implemented using a CNN or other neural network that uses FastText embeddings.

The training dataset used to dynamically train the bot switch algorithm 204 may be continuously updated in real-time to include communications exchanged between the different users and different automated bots associated with the different bot groups. As noted above, as automated bots within a bot group communicate with different users, the bot orchestrator 104 may dynamically update the training dataset to incorporate any communications exchanged amongst the automated bots and these different users. These communications may include annotations corresponding to the patterns and/or intents associated with these communications, which may be used to perform re-classification of the automated bots according to these patterns and/or intents (if needed). Over time, as more communications exchanged between automated bots 108 within the bot group 106 and different users, the training dataset may be expanded and used to dynamically re-train the bot switch algorithm 204 and perform reclassification of the automated bots 108 according to any real-time changes to discoverable patterns and/or intents.

In some instances, the training dataset may be continuously updated to incorporate feedback corresponding to communications exchanged amongst different users and the automated bots associated with different bot groups. As noted above, if a user expresses that an automated bot is not providing relevant responses to the user's communicated intent or other issue (e.g., the user expresses frustration with the automated bot, the user provides negative responses to communications generated by the automated bot, etc.), the bot orchestrator 104 may determine that the bot switch algorithm 204 has incorrectly assigned the intent associated with the user's communications to this automated bot. The bot orchestrator 104 may annotate these communications to further indicate which automated bot should have been assigned to this intent. Additionally, or alternatively, the bot orchestrator 104 may determine whether the intent classifications defined by the bot switch algorithm 204 are resulting in intent classification confusion. Accordingly, the bot orchestrator 104 may communicate with the brand 110 to identify the appropriate intent classifications for the automated bots 108 and accordingly annotate the communications within the dataset (including the newly received communications subject to the received feedback) to indicate the correct intent classifications. This updated dataset may be used to dynamically retrain the bot switch algorithm 204 to better identify the patterns and/or intents associated with newly exchanged communications and to identify the automated bots associated with these patterns and/or intents.

In an embodiment, the bot switch algorithm 204 includes an NLU engine that is dynamically trained to match or approximate a user's exchanged communication against a set of phrases, utterances, and/or knowledge base articles. Accordingly, the bot switch algorithm 204 may determine, in real-time or near real-time for a newly exchanged communication, a confidence score or threshold value corresponding to the likelihood of a particular intent being present in the communication. For instance, possible confidence scores or threshold values may indicate an approximate level of confidence in matching a received communication to each possible intent. The bot orchestrator 104, through the bot switch algorithm 204, may configure a threshold limit whereby if the confidence score or threshold value does not exceed this threshold limit, the bot switch algorithm 204 may automatically determine that the corresponding intent is likely not present in the communication and the bot switch algorithm 204 may not transfer the communications session to the automated bot associated with this intent. However, if the bot switch algorithm 204 determines that the corresponding intent is likely present in the communication based on the confidence score or threshold value for the communication, the bot switch algorithm 204 may determine whether the automated bot engaged in the communications session is associated with the intent and, if not, identify the appropriate automated bot to which the communications session is to be transferred to for addressing the intent.

The NLU engine implemented by the bot switch algorithm 204 may be dynamically trained in real-time using a dataset that includes sample intents and training phrases (e.g., historical phrases exchanged between actual users and automated bots, hypothetical phrases exchanged between hypothetical users and automated bots, etc.). This dataset may include, for each sample intent, a pre-defined number of sample training phrases that are known to be associated with the sample intent. These sample training phrases may be dynamically generated using generative artificial intelligence or other artificial intelligence methods. Alternatively, these sample training phrases may be obtained from historical communications sessions for which correlations between user phrases and intents are known.

The sample intents included in the dataset may correspond to a domain or collection of related intents and entities (e.g., automated bots, etc.). For instance, when generating the bot group 106, a brand 110 may select a pre-defined domain that includes a set of intents that are frequently expressed by users for the particular function or environment associated with the bot group 106. As another example, the brand 110 may select a pre-defined domain that includes a set of intents that are frequently expressed by users across multiple functions and/or environment and, thus, are frequently encountered in any type of communications session. This pre-defined domain may be modified by the brand 110 according to any intents that may be encountered during communications sessions between users and the different automated bots 108 associated with the bot group 106. In some instances, the brand 110 may define an intent domain that includes the intents that are associated with the different automated bots 108 within the bot group 106. As the bot switch algorithm 204 classifies communications exchanged between users and automated bots 108 according to the likelihood of different intents being included within these communications, the bot switch algorithm 204 may dynamically use the intent domain defined by the brand 110 along with the calculated confidence scores or threshold values to determine the intent that best matches the communications.

In an embodiment, the bot switch algorithm 204 generates a taxonomy of intents through processing of the dataset. This taxonomy of intents may be used to identify different intents that may be likely encountered through communications sessions between different users and the automated bots 108 in the bot group 106. This taxonomy of intents may include any intents defined through an intent domain (e.g., a pre-defined intent domain, an intent domain defined by the brand 110, etc.). As the bot switch algorithm 204 generates this taxonomy of intents, the bot orchestrator 104 may evaluate the taxonomy of intents to identify any intent taxonomy overlaps that may impact performance of the bot switch algorithm 204 in detecting the appropriate intent for a given set of exchanged communications, which may impact selection of an automated bot for the communications session. If the bot orchestrator 104 identifies any intent taxonomy overlaps in the taxonomy of intents generated by the bot switch algorithm 204, the bot orchestrator 104 may modify the dataset used to dynamically train the bot switch algorithm 204 to include sample intents and training phrases that are diverse (e.g., each sample intent and corresponding training phrases are distinguishable from other intents and other training phrases, etc.). Through this training process, the bot switch algorithm 204 may automatically update the taxonomy of intents such that a corresponding intent domain includes a set number of intents that may be associated with different automated bots within the bot group 106.

The bot switch algorithm 204, in an embodiment, can further be dynamically re-trained to adjust the taxonomy of intents in real-time as communications are exchanged between different users and different automated bots during ongoing communications sessions. As noted above, when a communications session is transferred to an automated bot within the bot group 106, subsequent communications between the automated bot and the user 112 may be evaluated in real-time and as these communications are exchanged to determine whether the automated bot is successful in addressing the underlying intent or other issue expressed by the user 112 and identified by the bot switch algorithm 204. If the automated bot is unable to address the underlying intent or other issue expressed by the user 112, it may be an indication that the bot switch algorithm 204 has incorrectly associated the automated bot with the underlying intent or other issue. Additionally, or alternatively, this may serve as an indication that the taxonomy of intents generated by the bot switch algorithm 204 has resulted in overlaps that are causing confusion. Accordingly, based on this feedback, the bot switch algorithm 204 may be updated in order to reduce the likelihood of the automated bot being selected for the identified intent or other issue. Further, the taxonomy of intents may be updated in order to remove any identified overlaps or other issues that may result in confusion. The dataset used to dynamically train the bot switch algorithm 204 may be updated to incorporate this feedback such that, when the dataset is updated, a new version of the bot switch algorithm 204 is generated that incorporates the provided feedback. This process of updating the bot switch algorithm 204 may be performed continuously, in real-time or near real-time, as communications are exchanged amongst different users and different automated bots for different communications sessions and as feedback is received with regard to these different communications sessions.

It should be noted that, in some instances, the bot switch algorithm 204 may be implemented without a bot orchestrator 104. In environments in which a bot orchestrator 104 is not implemented, each automated bot within a bot group 106 may implement a version of the bot switch algorithm 204 to dynamically, and in real-time, detect a user's communicated intent as communications are exchanged between the user 112 and the automated bot. If the automated bot determines that it is incapable of addressing the current intent, the automated bot (through the bot switch algorithm 204) may determine whether another automated bot within the bot group 106 is associated with the current intent and, thus, may communicate with the user 112 to address the intent. For instance, the automated bot may query the other automated bots 108 within the bot group 106 to determine whether any of these other automated bots 108 can address the identified intent or other issue expressed by the user 112. If the automated bot identifies another automated bot within the bot group 106 that is associated with the identified intent or other issue, the automated bot may automatically transfer the communications session to this other automated bot.

As noted above, the brand 110 can designate an automated bot from the set of automated bots 108 in a bot group 106 to communicate with a user 112 when the communications session between the user 112 and the bot group 106 is initially facilitated by the brand platform service 102 through the user messaging system 202. Alternatively, absent such a designation, the bot orchestrator 104 may randomly select an automated bot from the bot group 106 that may initially engage the user 112 through the communications session when the communications session is initially facilitated. In some examples, this first automated bot may be associated with one or more patterns and/or intents such that the automated bot may serve the dual purpose of initially greeting a user 112 and addressing any issues corresponding to the assigned patterns and/or intents.

In an embodiment, as the user 112 communicates with an automated bot associated with the bot group 106, the bot switch algorithm 204 may continuously, and in real-time, process these communications to detect any changes in the patterns and/or intents associated with the communications session. For instance, the bot switch algorithm 204 may continuously process the exchanged communications to identify any current patterns and/or intents associated with the communications session. Based on the identified patterns and/or intents, the bot orchestrator 104 may determine whether the current automated bot engaged with the user 112 through the communications session can address the identified intent or is otherwise associated with the identified patterns and/or intents. If the bot orchestrator 104 determines that the current automated bot can address the identified intent or is otherwise associated with the identified patterns and/or intents, the bot orchestrator 104 may allow the automated to continue communicating with user 112 through the communications session. Further, the bot orchestrator 104, through the bot switch algorithm 204, may continue to process new communications between the user 112 and the automated bot to detect, in real-time, any changes to the previously identified patterns and/or intents.

If the bot orchestrator 104 determines that the automated bot currently engaged with the user 112 is not associated with the identified pattern and/or intent (as determined through the bot switch algorithm 204), the bot orchestrator 104 may determine whether another automated bot within the bot group 106 is associated with the identified pattern and/or intent. As noted above, the bot switch algorithm 204 may dynamically process communications exchanged between the automated bots 108 associated with the bot group 106 and different users through different communications sessions to automatically identify any patterns and/or intents that are associated with each of the automated bots 108 within the bot group 106. Accordingly, the bot orchestrator 104 may automatically use this output from the bot switch algorithm 204 to associate these identified patterns and/or intents with the corresponding automated bots 108 within the bot group 106. This allows the bot orchestrator 104 to automatically evaluate the other automated bots 108 within the bot group 106 to identify the automated bot that is associated with the current patterns and/or intents detected from the ongoing communications session. Once the bot orchestrator 104 has identified, from the bot group 106, an automated bot that is associated with the current patterns and/or intents, the bot orchestrator 104 may dynamically transfer the communications session from the current automated bot to the identified automated bot.

In some instances, the bot orchestrator 104 may be unable to identify an automated bot that is associated with the current patterns and/or intents detected from the ongoing communications session. In such instances, the bot orchestrator 104 may transmit, over the ongoing communications session, a fallback message to the user 112. The fallback message may indicate that the identified intent cannot be resolved through the communications session. In some instances, the fallback message may provide the user 112 with information (e.g., electronic mail address, telephone number, etc.) for contacting a live agent (i.e., a human agent that may be knowledgeable with regard to one or more intents or other issues that users may wish to have resolved) that may be able to address the user's intent. In an embodiment, if the bot orchestrator 104 is unable to identify an automated bot that is associated with the current patterns and/or intents detected from the ongoing communications session, the bot orchestrator 104 can automatically transfer the communications to a live agent associated with the brand 110.

As noted above, the bot orchestrator 104 can also transfer an ongoing communications session from an automated bot associated with the bot group 106 to a live agent based on different characteristics associated with the communications exchanged during the ongoing communications session. For instance, the bot orchestrator 104, through a machine learning algorithm or artificial intelligence dynamically trained to determine a user's sentiment during an ongoing communications session, may generate a dynamic sentiment parameter that represents the user's sentiment (as expressed through their communications exchanged through the communications session). For example, if the dynamic sentiment parameter corresponds to an indication of user frustration with an automated bot, the bot orchestrator 104 may automatically switch the communications session from the automated bot to a live agent. In some instances, the communications session between the user and the automated bots 108 associated with the bot group 106 may be monitored by a live agent associated with the brand 110. The live agent may intervene in the communications session if they detect that the user 112 is becoming frustrated with an automated bot engaged in the communications session or that the automated bot is otherwise incapable of resolving the user's intent or other issue and no other automated bot is available within the bot group 106 that can address the intent or other issue. In some instances, the live agent may leverage the aforementioned machine learning algorithm or artificial intelligence to automatically determine the user's sentiment and, accordingly, determine when to intervene on the ongoing communications session.

In an embodiment, and as illustrated in FIG. 2, the brand platform service 102 can further include a contextual state module 206 that may be implemented to persist any contextual information associated with a communications session. The contextual state module 206 may be implemented on a computing system of the brand platform service 102 or as an application executed by a computing system of the brand platform service 102. The contextual state module 206 may include a key-value datastore that may be used to persist the contextual information provided during ongoing communications sessions. For instance, if an automated bot, during an ongoing communications session, prompts the user 112 to provide their account number for a particular intent (e.g., determine an account balance, identify a set of recent transactions associated with an account, dispute a transaction associated with an account, etc.) and the user responds with their account number, the contextual state module 206 may automatically define a new key-value entry within the datastore that includes the user's account number. Returning to the illustrative example above in connection with FIG. 1, in response to the user communication “My account number is 801210-410,” the contextual state module 206, may generate a new key-value entry that indicates, for the field or “key” corresponding to the account number namespace, that the corresponding value corresponds to the user's account number (e.g., the field or key is defined as “ACCOUNT NUMBER,” etc.). The key-value entry may further indicate the supplied account number such that the complete key-value entry may take the form of “ACCOUNT NUMBER=801210-410” or other similar form.

As noted above, in some instances, the contextual state module 206 implements an NLP algorithm or other machine learning algorithm/artificial intelligence that is dynamically trained to process, in real-time, communications exchanged between users and automated bots as these communications are exchanged to extract any contextual information provided by these users. The NLP algorithm may be dynamically trained using a dataset of sample communications and known contextual information included in these communications. Further, the dataset may include expected key-value pairs corresponding to contextual information included in the sample communications. This may allow for evaluation of the NLP algorithm to determine whether the NLP algorithm is correctly extracting the contextual information from the supplied sample communications and dynamically generating accurate key-value pairs for the extracted contextual information. If there are any errors detected in the identification of contextual information and/or in generating the corresponding key-value pairs, the NLP algorithm may be retrained to improve the likelihood of the NLP algorithm accurately identifying the contextual information and generating corresponding key-value pairs.

The NLP algorithm implemented by the contextual state module 206 may also be updated as communications are exchanged between users and different automated bots through different ongoing communications sessions. Returning to the illustrative example provided in FIG. 1, where the user 112 was prompted by an automated bot to provide their account number and the user 112 has responded with an indication that their account number is “801210-410,” the contextual state module 206 may determine whether the NLP algorithm detected this account number and, accordingly, recorded this account number within the key-value datastore for the communications session. If the contextual state module 206 determines that a key-value entry for this account number has not been recorded, the contextual state module 206 may determine that the NLP algorithm has failed to detect and record this contextual information. As another illustrative example, if the communications session is transferred to another automated bot within the bot group 106, and the other automated bot prompts the user to again provide their account number, the contextual state module 206 may determine whether the contextual information was recorded in the key-value datastore when it was initially provided by the user 112. If the contextual information was recorded within the key-value datastore, the contextual state module 206 may further determine whether the correct key (e.g., “ACCOUNT NUMBER”) was generated for the entry. If the contextual state module 206 determines that the NLP algorithm correctly stored the contextual information provided by the user 112, but a subsequent automated bot prompts the user 112 to provide this contextual information, the contextual state module 206 may determine that the issue resides with the automated bot's configuration. Accordingly, the contextual state module 206 may notify the brand 110 of the issue to allow the brand 110 to address this deficiency in the automated bot.

The NLP algorithm implemented by the contextual state module 206 may be further updated according to feedback corresponding to the automatic identification of contextual information (or lack thereof) from exchanged communications. Returning to the earlier example where the user 112 is repeatedly prompted for their account number by different automated bots within a bot group 106, the contextual state module 206 may use these repeated prompts as feedback indicating that the provided contextual information was not detected and/or not properly recorded within the key-value datastore by the NLP algorithm. Accordingly, the contextual state module 206, the brand 110, or any other entity associated with the bot group 106 may annotate these communications submitted by the user 112 with the requested contextual to indicate the key-value entry that should have been generated by the NLP algorithm in response to these communications. This annotated datapoint may be added to the dataset used to train the NLP algorithm. This may allow for continued training of the NLP algorithm as new communications including contextual information are exchanged between users and automated bots.

In an embodiment, when the bot orchestrator 104 transfers a communications session from a first automated bot to a second automated bot within the bot group 106, the second automated bot may automatically query the contextual state module 206 to obtain any previously recorded contextual information associated with the ongoing communications session and/or with the user 112 engaged in the ongoing communications session. The automated bots 108 within a bot group 106 may be configured to further evaluate any previously provided contextual information from the contextual state module 206 to determine whether this previously provided contextual information may be used for any of the routines executed by the automated bots 108. For instance, if the user 112 previously provided their account number, and the second automated bot requires this account number to identify the user's previous transactions, the second automated bot may automatically use this previously provided account number in order to retrieve and provide the user 112 with an indication of their previous transactions without having to prompt the user 112 again to provide their account number. As another illustrative example, if the user 112 is prompted to provide their address in order to verify their identity, and the communications session is transferred to another automated bot that requires this address to facilitate delivery of an item previously ordered by the user 112, the other automated bot may automatically evaluate the retrieved contextual information from the contextual state module 206 to determine the user's address without requiring the other automated bot to prompt the user 112 to again provide their address.

In an embodiment, the brand platform service 102 allows the brand 110 or other entity defining a bot group 106 for a set of automated bots 108 to further define the different types of contextual information that may be relevant to communications sessions associated with the bot group 106. For example, a brand 110 may configure the namespace for each variable corresponding to different pieces of contextual information that may be obtained from users during communications sessions associated with the bot group 106. Further, the brand 110 may configure the automated bots 108 within the bot group 106 to dynamically record obtained contextual information according to these configured namespaces. This may obviate the need to dynamically generate new keys (i.e., namespaces) for key-value pairs corresponding to particular information that may not be used by any of the automated bots 108 within a bot group 106.

As noted above, when the bot orchestrator 104 transfers an ongoing communications session from a first automated bot to a second automated bot, the second automated bot may transmit an API call to the contextual state module 206 to retrieve the contextual information associated with the ongoing communications session and the user 112. The API call may include a GET command that indicates the namespaces (e.g., the types of contextual information being requested) and any properties that may be used to identify the appropriate key-value pairs that include the required contextual information. The properties may include unique information associated with the user 112 and/or the communications session (e.g., username, unique identifier for the communications session, timestamp corresponding to the time at which the communications session was initiated, etc.). In response to the API call, the contextual state module 206 may query the key-value datastore to identify any entries that satisfy the elements of the request. Accordingly, the contextual information module may return the requested contextual information to the automated bot. In some instances, the API call may include a generic GET command that does not make reference to specific namespaces or properties. In response to the generic GET command, the contextual state module 206 may return any available contextual information associated with the ongoing communications session and the user 112.

In an embodiment, if the automated bot determines that the required contextual information is not available (e.g., the contextual state module 206 does not maintain an entry including the contextual information, etc.), the automated bot may prompt the user 112 for the required contextual information. Returning to an earlier example, if the automated bot requires the user's account number in order to provide a response to the user's query for their account balance, and the contextual state module 206 does not maintain a key-value entry corresponding to the user's account number, the automated bot may prompt the user 112 to provide their account number. If the user 112 provides their account number in response to the request, the contextual state module 206, through the aforementioned NLP algorithm, may automatically define a key-value pair that includes the provided account number in association with a namespace corresponding to account numbers. For instance, the contextual state module 206, through the NLP algorithm, may identify the namespace for the contextual information (e.g., “ACCOUNT NUMBER,” etc.), a property that may uniquely associate the key-value pair with the user 112 (e.g., username, communications session identifier, timestamp corresponding to the communications session, etc.), and the corresponding value (e.g., “801210-410,” any other account number information provided by the user 112, etc.). In some instances, when the user 112 provides the requested contextual information, the automated bot may transmit an API call to the contextual state module 206 to define the new key-value pair for the received contextual information.

As noted above, contextual information maintained by the contextual state module 206 may be subject to an expiration or a “time to live” property whereby once the expiration or time period associated with the “time to live” property has passed, the contextual information may be automatically removed from the contextual state module 206. The expiration or “time to live” property may apply only to the key-value pairs (i.e., the contextual information) and not to the keys (i.e., namespaces) themselves. The expiration or “time to live” property for contextual information corresponding to a particular namespace may be pre-defined by the brand platform service 102 and applied by default. Alternatively, the expiration or “time to live” property may be defined by the brand 110 when implementing a bot group 106. The expiration or “time to live” property for any key-value pair may exceed the amount of time related to any given communications session. For example, the expiration or “time to live” property for contextual information corresponding to a particular namespace may be defined using longer timescales (e.g., hours, days, weeks, months, etc.) than that normally associated with ongoing communications sessions. This may allow this contextual information to persist and remain available for future communications sessions associated with the same user 112. This may reduce the number of prompts that are provided to the user 112 through a communications session by the different automated bots 108 associated with a bot group 106.

In an embodiment, the bot orchestrator 104 can implement a set of policies that may be used to perform particular actions based on communications exchanged between users and automated bots within ongoing communications sessions. These policies may be defined by the brand 110 and/or the brand platform service 102 (by default) and can be designated as being applicable to communications sessions between users and automated bots 108 associated with the bot group 106. In an embodiment, the set of policies can define when the bot orchestrator 104, a live agent, or other entity may intervene in an ongoing communications session between a user 112 and any of the automated bots 108 associated with the bot group 106. For example, the brand 110 and/or the brand platform service 102 may implement a policy that prohibits the use of profanity within active communications sessions and automatically causes a default message to be communicated to users that engage in the use of profanity during an active communications session. When the bot orchestrator 104, through the bot switch algorithm 204, processes communications exchanged between a user 112 and automated bots 108 associated with the bot group 106, the bot orchestrator 104 may further evaluate these communications according to the applicable policies associated with the bot group 106. Returning to the earlier illustrative example of policies associated with the use of profanity, if the bot orchestrator 104 detects, from these communications, the use of profanity, the bot orchestrator 104 may automatically perform any actions defined in the policy to address this violation of the applicable policy. For instance, the bot orchestrator 104 may automatically transmit a notification to the user 112 through the communications session to cease their use of profanity during the communications session. As another example, the bot orchestrator 104 may mute or otherwise restrict the user's ability to exchange communications through the communications session for a pre-defined period of time (e.g., one minute, five minutes, etc.). In some instances, the bot orchestrator 104 may automatically terminate the communications session.

At the conclusion of a communications session between the user 112 and one or more automated bots 108 from the bot group 106, the communications exchanged during the communications session can be evaluated to obtain any feedback that may be used to update the bot switch algorithm 204 and/or the NLP algorithm implemented by the contextual state module 206. For instance, if the bot switch algorithm 204 erroneously assigned a particular intent to an automated bot, and the automated bot was subsequently unable to address the particular intent during the communications session (e.g., the automated bot exchanged communications unrelated to the particular intent, the automated bot defaulted to a fallback message as a result of being unable to address the particular intent, the user communicated frustration or other sentiment indicative of the automated bot's inability to address the intent, etc.), the communications exchanged during the communications session may be evaluated to determine the appropriate intent communicated by the user 112 and the appropriate automated bot (if any) to which the communications session should have been transferred to in order to address the user's intent. Through this evaluation, the corresponding communications may be annotated and added to the dataset used to dynamically train the bot switch algorithm 204. As another illustrative example, if the NLP algorithm implemented by the contextual state module 206 failed to detect contextual information provided by a user 112 during a communications session and/or failed to generate a new key-value pair corresponding to detected contextual information resulting in repeated prompts for this contextual information, the communications corresponding to the provided contextual information may be annotated and added to the dataset used to train the NLP algorithm.

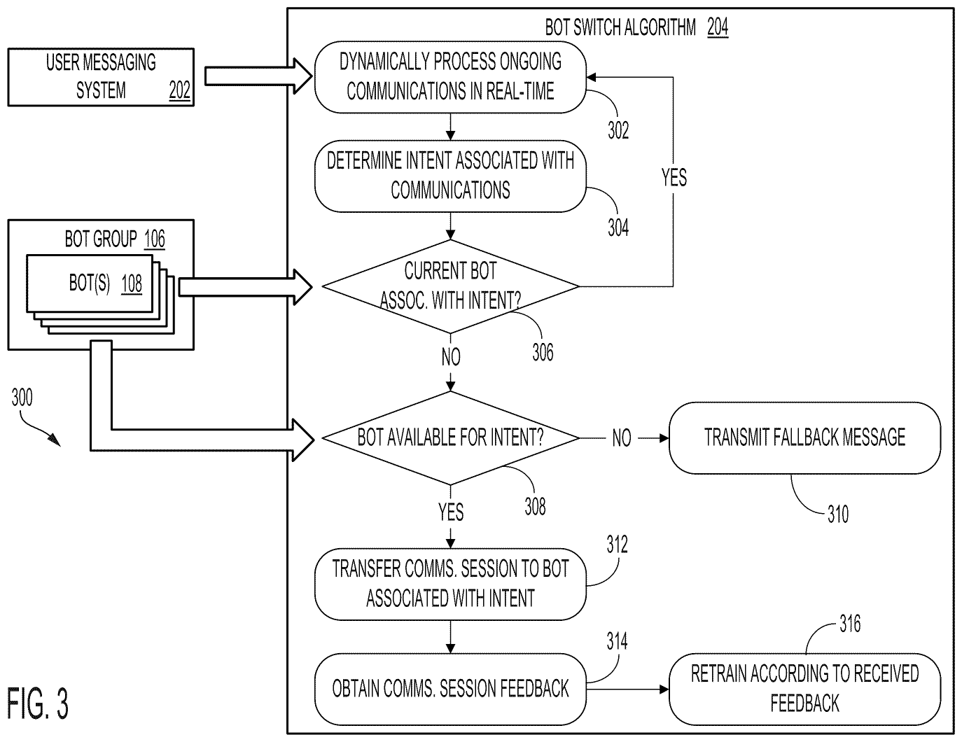

FIG. 3 shows an illustrative example of an environment 300 in which a bot switch algorithm 204 automatically and in real-time processes communications exchanged between a user and one or more automated bots 108 associated with a bot group 106 to automatically transfer the communications to another bot within the bot group 106 based on a detected intent in accordance with at least one embodiment. As noted above, the brand platform service may implement a bot switch algorithm 204 that is dynamically trained in real-time to process communications between users and automated bots 108 associated with a bot group 106 to associate different intents and patterns with the automated bots 108 and to determine whether to transfer an ongoing communications session from a first automated bot to a second automated bot based on a detected pattern or intent. The bot switch algorithm 204 may be implemented as a component of a bot orchestrator that is implemented for each bot group 106 defined by one or more brands associated with the brand platform service. Alternatively, the bot switch algorithm 204 may be implemented without a bot orchestrator. In environments in which a bot orchestrator is not implemented, each automated bot within a bot group 106 may implement a version of the bot switch algorithm 204 to perform the operations described herein.

In the environment 300, the bot switch algorithm 204, at step 302, may dynamically process ongoing communications between a user and an automated bot associated with the bot group 106 in real-time and as these communications are exchanged. For instance, the user messaging system 202 may maintain, for each ongoing communications session facilitated by the brand platform service through the user messaging system 202, a data stream through which communications exchanged through the ongoing communications session are automatically transmitted to the bot switch algorithm 204 in real-time or near real-time. Alternatively, the bot switch algorithm 204 may be configured to automatically, and in real-time or near real-time, monitor ongoing communications sessions to obtain any newly exchanged communications from these ongoing communications sessions for processing.

At step 304, the bot switch algorithm 204 may determine an intent and/or pattern associated with the communications exchanged through the ongoing communications session. As noted above, in an embodiment, the bot switch algorithm 204 is a classification algorithm that is dynamically trained in real-time using a dataset of sample communications sessions, corresponding automated bot responses, and known intents and patterns associated with the communications included in these sample communications sessions. As part of this training process, the bot switch algorithm 204 may process this dataset to identify any patterns and/or intents associated with the sample communications sessions and classify the automated bots associated with these sample communications sessions according to the identified patterns and/or intents. Based on these sample classifications, the bot switch algorithm 204 may be evaluated to determine its accuracy in classifying these sample communications as being associated with a particular pattern or intent.

In an embodiment, to determine the intent and/or pattern associated with the exchanged communications, the bot switch algorithm 204 implements an NLU engine that is dynamically trained to determine threshold values for each possible intent associated with the automated bots within the bot group 106. The NLU engine may match or approximate the exchanged communications against a set of phrases, utterances, and/or knowledge base articles. Through the NLU engine, the bot switch algorithm 204, at step 304, may determine a confidence score or threshold value corresponding to the likelihood of a particular intent being present in the exchanged communications. Based on the confidence score or threshold value assigned to the exchanged communications, the bot switch algorithm 204 may determine the intent that is associated with the exchanged communications. For instance, if the confidence score or threshold value for a particular intent is below a pre-defined threshold, the bot switch algorithm 204 may determine that the particular intent is not present in the exchanged communications. Alternatively, if the confidence score or threshold value for the particular intent exceeds the pre-defined threshold, the bot switch algorithm 204 may determine that the particular intent is likely present within the exchanged communications. In some instances, if multiple intent matches are found (i.e., the confidences scores or threshold values for multiple intents exceeds the pre-defined threshold), the bot switch algorithm 204 may select the intent having the highest confidence score or threshold value. Further, if these multiple intents have the same confidence score or threshold value, the bot switch algorithm 204 may select a particular intent at random from these multiple intents.

Based on the identified pattern or intent, the bot switch algorithm 204, at step 306, may determine whether the automated bot currently engaged with the user through the communications session is associated with the identified pattern or intent. As noted above, the bot switch algorithm 204 is dynamically trained in real-time to discover the patterns and/or intents associated with each automated bot added to a bot group 106. For instance, a dataset of sample communications sessions (e.g., historical communications sessions, hypothetical communications sessions, etc.) and corresponding automated bot responses (e.g., actual automated bot responses, hypothetical automated bot responses, etc.) may be analyzed using the bot switch algorithm 204 to identify different patterns and/or intents that are associated with the different automated bots associated with the dataset. The bot switch algorithm 204 may be dynamically trained in real-time by classifying communications between a sample user and an automated bot according to one or more vectors of similarity between the sample communications and other clusters of communications corresponding to different patterns and/or intents that may be associated with particular automated bots. Thus, the bot switch algorithm 204 may perform such clustering and obtain partial matches among other clusters of patterns and/or intents to identify the capabilities of each automated bot within a bot group 106. According to these identified capabilities, the bot switch algorithm 204 may determine whether it has previously classified the current automated bot as being associated with the identified intent. If the bot switch algorithm 204 determines that the current automated bot is associated with the identified intent, the bot switch algorithm 204 may continue to dynamically process any newly exchanged communications in real-time and as these communications are exchanged to detect any changes to the identified pattern or intent.

If the bot switch algorithm 204 determines that the current automated bot engaged in the communications session is not associated with the identified pattern or intent, the bot switch algorithm 204, at step 308, may determine whether the bot group 106 includes an automated bot that is associated with the identified pattern or intent. For instance, based on the previously performed classification of the different automated bots 108 within the bot group 106, the bot switch algorithm 204 may determine whether an automated bot from the set of automated bots 108 is assigned to the identified pattern or intent.

If the bot switch algorithm 204 is unable to identify an automated bot that is associated with the identified pattern or intent, the bot switch algorithm 204, at step 310, may automatically transmit a fallback message to the user engaged in the ongoing communications session. The fallback message may indicate that the identified intent cannot be resolved through the communications session. In some instances, the fallback message may include information (e.g., electronic mail address, telephone number, etc.) for contacting a live agent (i.e., a human agent that may be knowledgeable with regard to one or more intents or other issues that users may wish to have resolved) that may be able to address the user's intent. In some instances, the bot switch algorithm 204 may transmit an executable instruction to the current automated bot to provide the fallback message to the user through the ongoing communications session. Alternatively, the bot switch algorithm 204 may automatically intervene in the ongoing communications session to transmit the fallback message to the user. In some instances, if the bot switch algorithm 204 is unable to identify an automated bot that is associated with the current pattern or intent detected from the ongoing communications session, the bot switch algorithm 204 can automatically transfer the communications session to a live agent associated with the brand.

If the bot switch algorithm 204 identifies an automated bot that is associated with the identified pattern or intent, the bot switch algorithm 204 may automatically, and in real-time, transfer the ongoing communications session from the current automated bot to the identified automated bot from the bot group 106. For instance, the bot switch algorithm 204 may transmit executable instructions to the current automated bot to automatically transfer the communications session to the identified automated bot within the bot group 106. Alternatively, the bot switch algorithm 204 may transmit an executable instruction or command to the current automated bot to disengage from the communications session. In such an instance, the bot switch algorithm 204 may access the bot group 106 to execute the identified automated bot. Upon execution, the identified automated bot may automatically join the communications session and engage the user.

In an embodiment, at step 312, the bot switch algorithm 204 continues to monitor the ongoing communications session to obtain feedback corresponding to the performance of the automated bots 108 engaged in the communications session with the user. For instance, the training dataset used to train the bot switch algorithm 204 may be continuously updated to incorporate feedback corresponding to communications exchanged amongst different users and the automated bots associated with different bot groups. As noted above, if a user expresses that an automated bot is not providing relevant responses to the user's communicated intent or other issue (e.g., the user expresses frustration with the automated bot, the user provides negative responses to communications generated by the automated bot, etc.), the brand platform service may determine that the bot switch algorithm 204 has incorrectly assigned the intent associated with the user's communications to this automated bot. These communications may be annotated to further indicate which automated bot should have been assigned to this intent. Additionally, or alternatively, the brand platform service may determine whether the intent classifications defined by the bot switch algorithm 204 are resulting in intent classification confusion. Accordingly, the exchanged communications in the dataset (including the newly received communications subject to the received feedback) may be annotated to indicate the correct intent classifications. As another illustrative example of possible feedback that may be used to retrain the bot switch algorithm 204, if the bot switch algorithm 204 erroneously assigned a particular intent to an automated bot, and the automated bot was subsequently unable to address the particular intent during the communications session (e.g., the automated bot exchanged communications unrelated to the particular intent, the automated bot defaulted to a fallback message as a result of being unable to address the particular intent, the user communicated frustration or other sentiment indicative of the automated bot's inability to address the intent, etc.), the communications exchanged during the communications session may be evaluated to determine the appropriate intent communicated by the user and the appropriate automated bot (if any) to which the communications session should have been transferred to in order to address the user's intent. This feedback may be obtained in real-time as communications are exchanged between the user and one or more automated bots 108 from the bot group 106. Additionally, or alternatively, the feedback may be obtained at the conclusion of the communications session.

This updated dataset may be used, at step 316, to dynamically retrain the bot switch algorithm 204 to better identify the patterns and/or intents associated with newly exchanged communications and to identify the automated bots associated with these patterns and/or intents. It should be noted that the bot switch algorithm 204 is continuously updated in real-time as communications are exchanged via different ongoing communications sessions. For instance, any feedback or other annotations made to communications exchanged during a particular communications session may be used to dynamically retrain the bot switch algorithm 204 while the bot switch algorithm 204 continuously, and simultaneously, processes communications associated with other ongoing communications sessions. This allows for the bot switch algorithm 204 to be constantly updated in real-time based on feedback corresponding to these communications sessions and as the corresponding communications are exchanged.

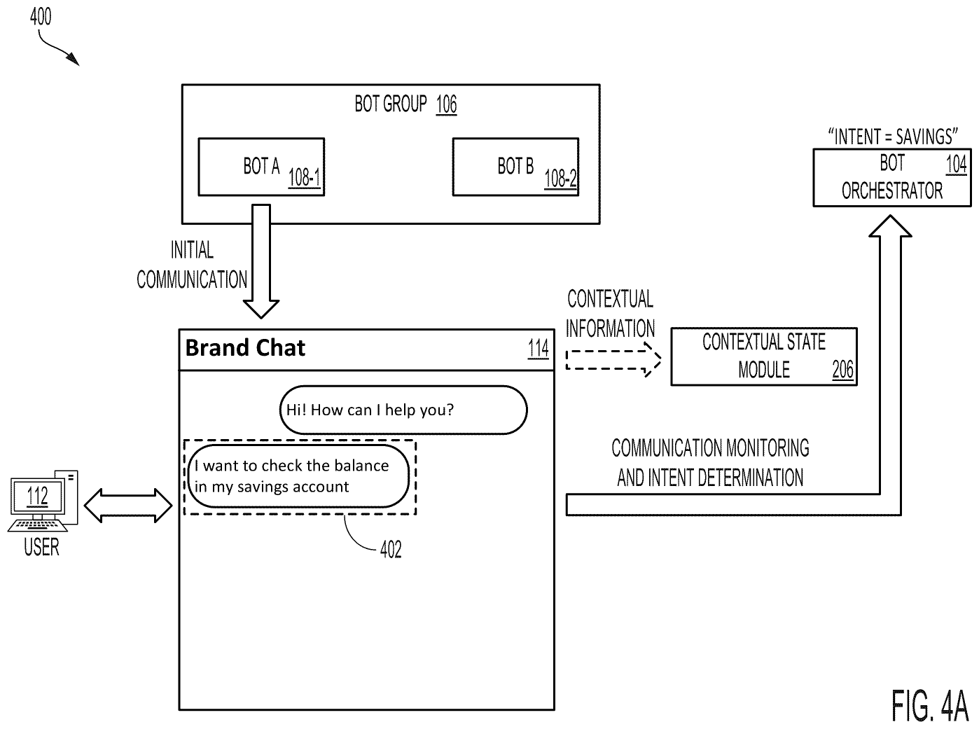

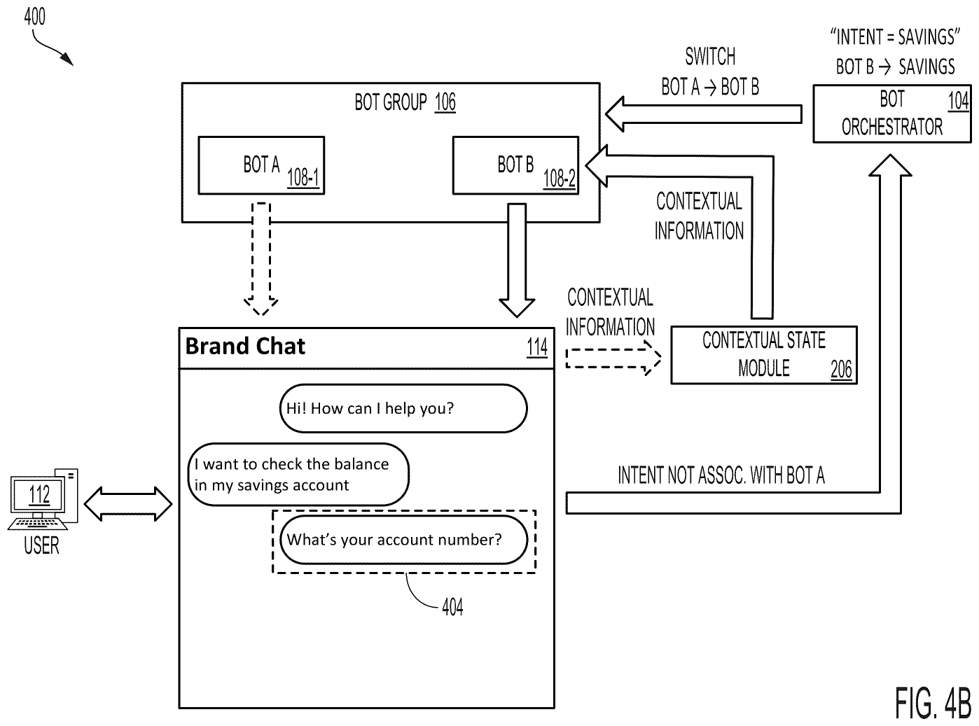

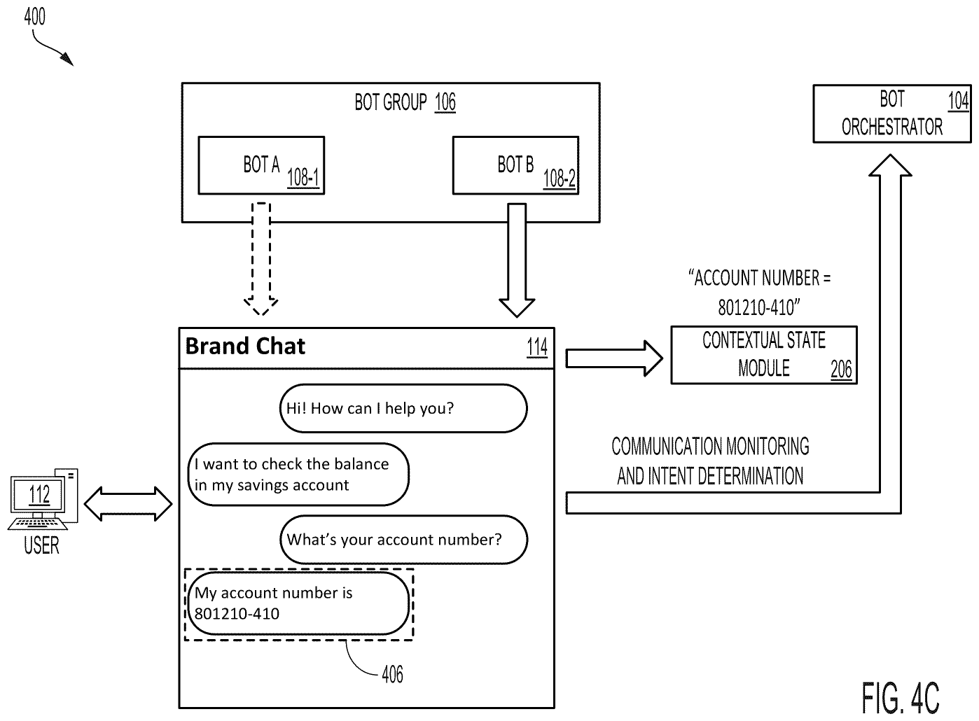

FIGS. 4A-4C show an illustrative example of an environment 400 in which a bot orchestrator 104 dynamically transfers a communications session 114 between a user 112 and a first bot 108-1 associated with a bot group 106 to a second bot 108-2 in response to detecting an intent associated with the second bot 108-2 in accordance with at least one embodiment. In the environment 400, and as illustrated in FIG. 4A, the user 112 may be engaged in a communications session 114 with a first bot 108-1 associated with a bot group 106. As noted above, the user 112, through a GUI provided through a website or application implemented by the brand platform service on behalf of a particular brand, may select an option to request a new communications session 114 in order to address a particular intent or issue. Returning to an earlier illustrative example, through this GUI, the brand platform service may provide the user 112 with an option to initiate a new communications session and with additional options corresponding to the different brand functions and/or environments in which the brand operates. These additional options may be used to determine which bot group 106 is to be associated with the new communications session 114.

When the brand platform service, through the user messaging system, facilitates a communications session 114 between the user 112 and the bot group 106 according to the particular options selected by the user 112, an automated bot 108-1 from the bot group 106 may initially engage with the user 112 in order to determine the user's intent or issue that is to be resolved. In an embodiment, the automated bot 108-1 is selected according to the configuration of the bot group 106 and the corresponding automated bots within the bot group 106, as defined by the brand. For instance, a brand may configure the automated bot 108-1 to automatically engage users when a new communications session 114 is facilitated between the user 112 and the bot group 106. Accordingly, when the communications session 114 is established, the automated bot 108-1 may automatically engage the user 112. In some embodiments, the automated bot 108-1 is associated with one or more patterns and/or intents such that the automated bot 108-1 may serve the dual purpose of initiating the communications session 114 with the user 112 and addressing any issues corresponding to the assigned one or more patterns and/or intents.

In an embodiment, when the automated bot 108-1 engages the user 112 through the communications session 114, the automated bot 108-1 may query the contextual state module 206 to identify any contextual information that may be associated with the user 112 and/or the communications session 114. The query may include any identifying information associated with the user 112 (e.g., name, electronic mail address, telephone number, etc.). This identifying information may be provided by the user 112 when accessing the brand platform service to initiate a new communications session. As noted above, the contextual state module 206 may include a key-value datastore that may be used to persist contextual information provided during ongoing communications sessions. Returning to an earlier illustrative example, if an automated bot, during an ongoing communications session, prompts the user 112 to provide their account number for a particular intent (e.g., determine an account balance, identify a set of recent transactions associated with an account, dispute a transaction associated with an account, etc.) and the user 112 responds with their account number, the contextual state module 206 may automatically define a new key-value entry within the datastore that includes the user's account number.

The contextual information maintained by the contextual state module 206 may be subject to an expiration or a “time to live” property whereby once the expiration or time period associated with the “time to live” property has passed, the contextual information may be automatically removed from the contextual state module 206. The expiration or “time to live” property for any key-value pair may exceed the amount of time related to any given communications session. Thus, if the user 112 has previously engaged with automated bots associated with the brand, the contextual state module 206 may maintain contextual information obtained from these previous communications sessions and associated with the user 112.

In response to the query from the automated bot 108-1, the contextual state module 206 may provide the automated bot 108-1 with any available contextual information associated with the user 112. For instance, using any provided identifying information associated with the user 112, the contextual state module 206 may query the myriad key-value entries maintained by the contextual state module 206 to identify any entries that include properties associated with the provided identifying information. Accordingly, the contextual state module 206 may provide these identified entries to the automated bot 108-1. Based on the configuration of the automated bot 108-1, the automated bot 108-1 may use the provided entries to obtain any contextual information that may be used for performing certain actions or routines without prompting the user 112 to provide the required contextual information.

As illustrated in FIG. 4A, when the automated bot 108-1 initially engages the user 112, the automated bot 108-1 may greet the user by transmitting, through the communications session 114, the message “Hi! How can I help you?” This message may be used to prompt the user 112 to indicate what their intent or issue is that they wish to have resolved by the bot group 106. In response to this prompt, the user 112 has provided a response 402 indicating that they would like to check the balance of their savings account. The response 402 may indicate the user's intent or issue that they would like to have resolved by the brand (e.g., determining the balance of their savings account).

As noted above, the brand platform service may implement a bot orchestrator 104 that may automatically, and in real-time or near real-time, analyze any communications exchanged over the communications session 114 to identify any patterns and/or intents associated with these communications. The bot orchestrator 104, through a bot switch algorithm (such as bot switch algorithm 204 as described above in connection with FIGS. 2 and 3), may dynamically, and in real-time or near real-time, process the response 402 provided by the user 112 through the communications session 114 to detect that the user's particular intent corresponds to a desire to check their savings account balance (e.g., “Intent=Savings”). For instance, the bot switch algorithm may determine, in real-time or near real-time for the response 402, a confidence score or threshold value corresponding to the likelihood of a particular intent being present in the response 402. As illustrated in FIG. 4A, the bot orchestrator 104, through the bot switch algorithm, has determined that the intent “Savings” is likely present in the response 402 based on the confidence score or threshold value corresponding to the intent and for the response 402. In response to determining that the current intent associated with the communications session 114 is “Savings,” the bot orchestrator 104 may determine whether the automated bot 108-1 engaged in the communications session 114 is associated with the “Savings” intent and, if not, identify the appropriate automated bot to which the communications session 114 may be transferred to for addressing the “Savings” intent.

As illustrated in FIG. 4B, the bot orchestrator 104 has determined that the “Savings” intent is not associated with automated bot 108-1 but rather automated bot 108-2 of the bot group 106. Accordingly, the bot orchestrator 104 may automatically, and in real-time, transfer the ongoing communications session 114 from the current automated bot 108-1 to the identified automated bot 108-2 from the bot group 106. For instance, the bot orchestrator 104 may transmit executable instructions to the automated bot 108-1 to automatically transfer the communications session 114 to the identified automated bot 108-2 within the bot group 106. Alternatively, the bot orchestrator 104 may transmit an executable instruction or command to the automated bot 108-1 to disengage from the communications session 114. If the bot orchestrator 104 causes the automated bot 108-1 to disengage from the communications session 114, the bot orchestrator 104 may access the bot group 106 to execute the automated bot 108-2. Execution of the automated bot 108-2 may cause the automated bot 108-2 to automatically join the communications session 114 and engage the user 112.

The automated bot 108-2, upon joining the communications session 114, may query the contextual state module 206 to obtain any available contextual information associated with the user 112 and/or the communications session 114. In response to the query from the automated bot 108-2, the contextual state module 206 may provide the automated bot 108-2 with any available contextual information associated with the user 112. The contextual state module 206 may use any provided identifying information associated with the user 112 to query the myriad key-value entries maintained by the contextual state module 206 to identify any entries that include properties associated with the provided identifying information. Accordingly, the contextual state module 206 may provide these identified entries to the automated bot 108-2. Based on the configuration of the automated bot 108-2, the automated bot 108-2 may use the provided entries to obtain any contextual information that may be used for performing certain actions or routines without prompting the user 112 to provide the required contextual information.

In some instances, when the communications session 114 is transferred from the automated bot 108-1 to the automated bot 108-2, the automated bot 108-1 may automatically pass any previously obtained contextual information to the automated bot 108-2. In some instances, the contextual information may be associated with different intents. Accordingly, the automated bot 108-2 may identify, from the provided contextual information, any contextual information corresponding to the intent associated with the automated bot 108-2. If no contextual information is available that is associated with the identified intent, the automated bot 108-2 may automatically rely on the most recent user communication (e.g., response 402) to automatically determine an appropriate communication that is responsive to this user communication.

As illustrated in FIG. 4B, the automated bot 108-2 may prompt the user 112, through an intent communication 404, to provide their account number associated with their savings account. The automated bot 108-2 may not be required to again greet the user 112 through the communications session 114, as the user 112 was already greeted by automated bot 108-1 as indicated through the contextual information associated with the communications session 114. Further, the automated bot 108-2 may not be required to prompt the user 112 for any previously provided identifying information garnered by the automated bot 108-1 and/or the brand platform service when facilitating the communications session 114. Thus, through the contextual state module 206 and through the transfer of the communications session 114 from the automated bot 108-1 to the automated bot 108-2, the automated bot 108-2 may automatically obtain any contextual information associated with the user 112 and the communications session 114 such that the automated bot 108-2 may not be required to again prompt the user 112 for this information.

In response to the communication 404 from the automated bot 108-2, the user 112, through the communications session 114, may provide a new response 406 that includes new contextual information associated with the user 112. For example, as illustrated in FIG. 4C, in response to the prompt from the automated bot 108-2 to provide their savings account number, the user 112 has provided a new response 406 that includes their savings account number (e.g., “My account number is 801210-410”). The automated bot 108-2 may use this response to perform one or more actions. For instance, using the provided account number, the automated bot 108-2 may access the user's savings account to determine the current balance of this account and, accordingly, provide a response through the communications session 114 that indicates the user's account balance.

In an embodiment, the contextual state module 206, through an NLP algorithm, may automatically define a key-value pair that includes the contextual information newly provided by the user 112 in response to a prompt from the automated bot 108-2. For instance, the contextual state module 206 may generate a new key-value pair that includes provided account number in association with a namespace corresponding to account numbers. For instance, the contextual state module 206, through the NLP algorithm, may identify the namespace for the contextual information (e.g., “ACCOUNT NUMBER,” etc.), a property that may uniquely associate the key-value pair with the user 112 (e.g., username, communications session identifier, timestamp corresponding to the communications session, etc.), and the corresponding value (e.g., “801210-410,” any other account number information provided by the user 112, etc.). In some instances, when the user 112 provides the requested contextual information, the automated bot 108-2 may transmit an API call to the contextual state module 206 to define the new key-value pair for the received contextual information.

As the automated bot 108-2 communicates with the user 112 through the communications session 114, the bot orchestrator 104 may continue to monitor the communications session 114 in real-time or near real-time to determine the current intent or pattern associated with the communications session 114. If the bot orchestrator 104 determines that the intent or pattern associated with the communications session 114 has changed, the bot orchestrator 104 may determine whether the automated bot 108-2 is associated with the new intent or pattern. If the automated bot 108-2 is not associated with the new intent or pattern, the bot orchestrator 104 may again evaluate the bot group 106 to determine whether there is another automated bot within the bot group 106 that is associated with this new pattern or intent.

The bot orchestrator 104, through its continued monitoring of the communications session 114, may continuously obtain feedback corresponding to the performance of the automated bots engaged in the communications session 114 with the user 112. For instance, if a user expresses that an automated bot is not providing relevant responses to the user's communicated intent or other issue, the brand orchestrator 104 may determine that the bot switch algorithm used to select which automated bot may engage the user 112 for a given intent has incorrectly assigned the user's communicated intent to this automated bot. These communications may be annotated to further indicate which automated bot from the bot group 106 should have been assigned to this intent. Additionally, or alternatively, the bot orchestrator 104 may determine whether the intent classifications defined by the bot switch algorithm are resulting in intent classification confusion. Accordingly, the exchanged communications in the dataset used to train the bot switch algorithm may be annotated to indicate the correct intent classifications. As another illustrative example of possible feedback that may be used to retrain the bot switch algorithm and improve the performance of the bot orchestrator 104, if the bot switch algorithm erroneously assigned a particular intent to an automated bot, and the automated bot was subsequently unable to address the particular intent during the communications session 114, the communications exchanged during the communications session 114 may be evaluated to determine the appropriate intent communicated by the user 112 and the appropriate automated bot from the bot group 106 (if any) to which the communications session 114 should have been transferred to. This feedback may be obtained in real-time as communications are exchanged between the user 112 and one or more automated bots from the bot group 106. Additionally, or alternatively, the feedback may be obtained at the conclusion of the communications session 114.

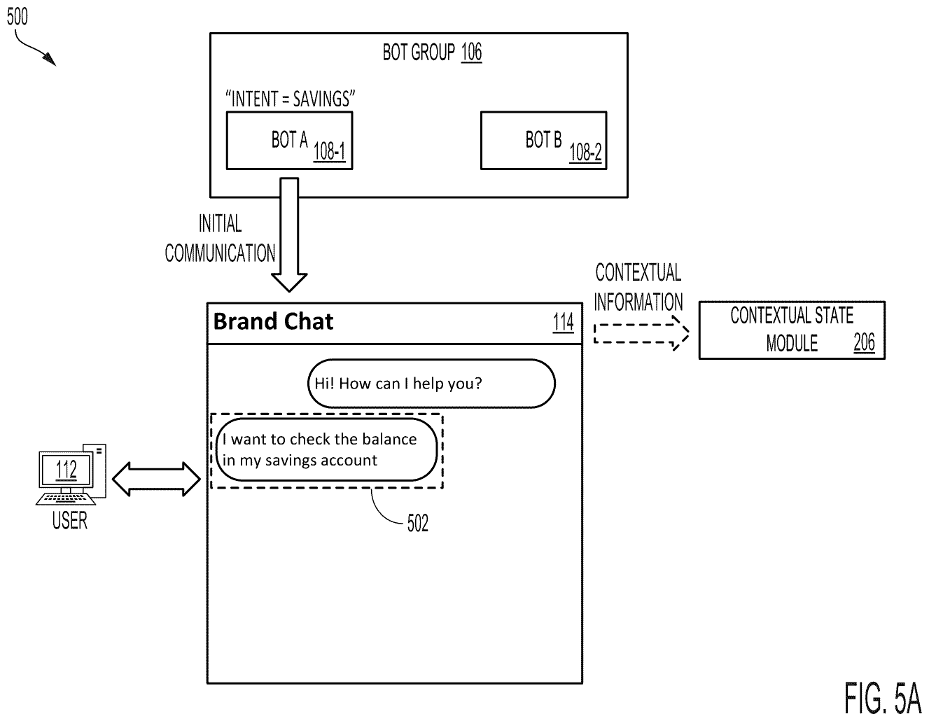

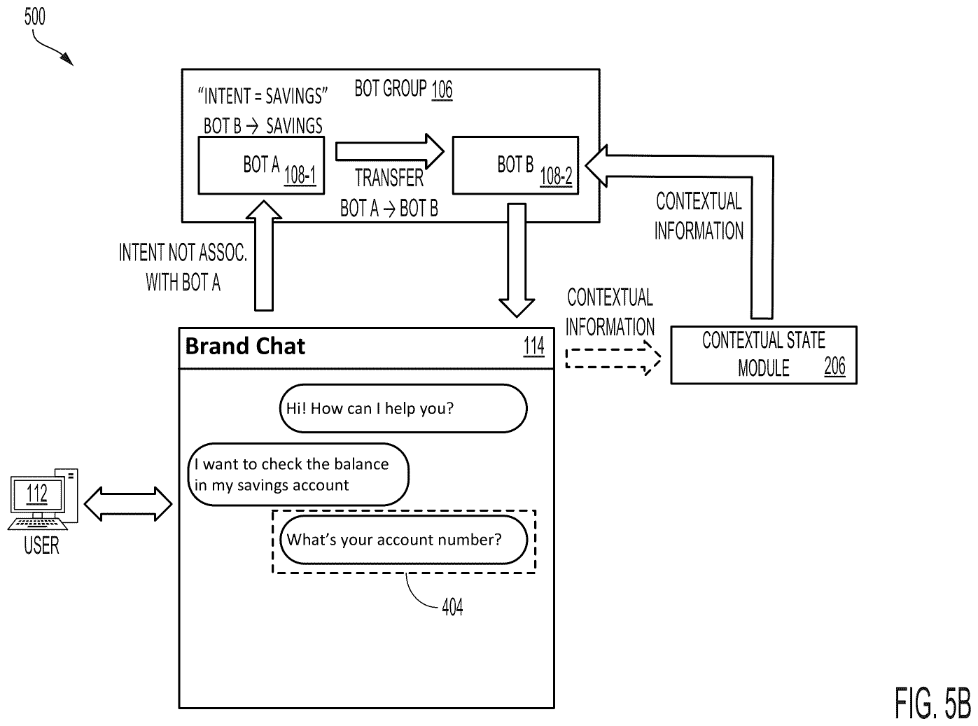

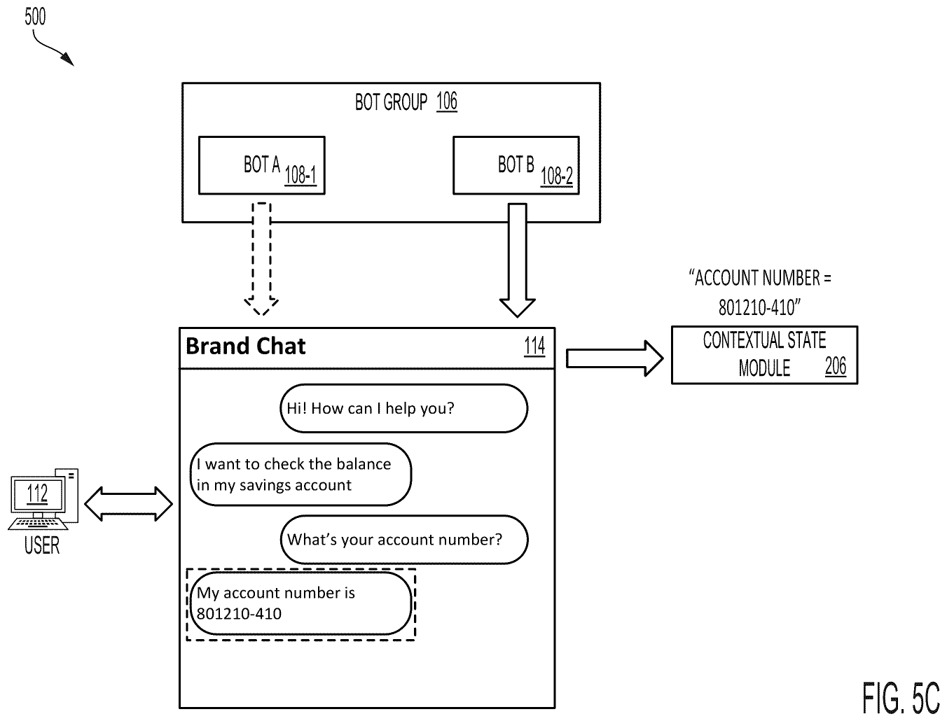

As noted above, in some instances, the brand platform service may implement a bot switch algorithm without a bot orchestrator. In such instances, each automated bot within a bot group may implement a version of the bot switch algorithm to dynamically, and in real-time, detect a user's communicated intent as communications are exchanged between the user and the automated bot and, accordingly, make bot switch determinations according to this communicated intent. FIGS. 5A-5C show an illustrative example of an environment 500 in which an automated bot engaged in a communications session 114 with a user 112 automatically transfers the communications session 114 to another automated bot based on a detected intent in accordance with at least one embodiment.

In the environment 500, and as illustrated in FIG. 5A, the user 112 may be engaged in a communications session 114 with a first bot 108-1 associated with a bot group 106. Similar to the environment 400 described above in connection with FIGS. 4A-4C, the user 112, through a GUI provided through a website or application implemented by the brand platform service on behalf of a particular brand, may select an option to request a new communications session 114 in order to address a particular intent or issue. Through this GUI, the brand platform service may provide the user 112 with an option to initiate a new communications session and with additional options corresponding to the different brand functions and/or environments in which the brand operates. These additional options may, thus, correspond to different bot groups implemented by the brand, within which different automated bots may collectively provide these different brand functions and/or environments.

When a new communications session is established between the user 112 and a particular bot group 106, an automated bot 108-1 from the bot group 106 may greet the user 112 and, additionally, prompt the user to indicate their intent or issue that is to be resolved. As noted above, the automated bot 108-1 may be selected according to a configuration of the bot group 106 and to the configuration of the automated bots within the bot group 106. These configurations may be defined by the brand when onboarding the automated bots and organizing these automated bots into different bot groups. For instance, the brand platform service may provide the brand with an interface (e.g., a GUI) through which the brand may onboard different automated bots configured to perform different functions. Further, through this GUI, the brand may organize these different automated bots into different bot groups according to the overall function that the automated bots within the bot group are to perform. As an illustrative example, a brand may define a “Checking and Savings” bot group, within which the brand may add a set of automated bots that may collectively address intents and/or issues related to user checking and savings accounts. In an embodiment, through the GUI, the brand can further enable collaboration amongst the different automated bots within the bot group 106 to facilitate dynamic transfers of communications sessions amongst the different automated bots according to detected intents or issues.

As noted above, the automated bots within a bot group 106, when engaging a user 112 through the communications session 114, may query the contextual state module 206 to retrieve any available contextual information that may be used to perform one or more functions. This may obviate the need for automated bots to repeatedly query users for any required contextual information if previously provided by these users during their corresponding communications sessions or during previous communications sessions (subject to an expiration or “time to live” for the contextual information). Further, this may reduce the number of communications that the automated bots may need to process in order to obtain required contextual information, thereby improving the efficiency of these automated bots while reducing the likelihood of errors in processing these communications. The query to the contextual state module 206 may include any identifying information associated with the user 112. As noted above, the contextual state module 206 may include a key-value datastore that may be used to persist contextual information provided during ongoing communications sessions. Returning to an earlier illustrative example, if an automated bot, during an ongoing communications session, prompts the user 112 to provide their account number for a particular intent and the user 112 responds with their account number, the contextual state module 206 may automatically define a new key-value entry within the datastore that includes the user's account number. Any subsequent automated bot engaged in the communications session with the user 112 may retrieve this account number from the contextual state module 206 without needing to again prompt the user 112 for their account number.

The contextual state module 206 provides several advantages. For instance, because the contextual state module 206 persists contextual information that is provided during ongoing communications sessions, the automated bots within the bot group 106 may automatically retrieve any available contextual information without needing to repeatedly prompt users (such as user 112) for contextual information previously provided by these users in response to prior prompts. This may improve the functionality of the bot orchestrator 104 as this reduction in user prompts resulting from leveraging of the contextual state module 206 may reduce the number of communications that may need to be processed by the bot orchestrator 104 to detect any changes to the patterns and/or intents associated with ongoing communications sessions.

As illustrated in FIG. 5A, the automated bot 108-1 has prompted the user 112, through the communications session 114, to indicate how the automated bot 108-1 may assist in addressing the user's intent or other issue that the user 112 wishes to have resolved. This prompt may serve as a signal to the user 112 to indicate, through the communications session 114, their present intent or current issue. In response to this prompt, the user 112 may provide a response 502 indicating that they would like to check the balance of their savings account.

In an embodiment, the automated bot 108-1 can dynamically process the response 502 through a bot switch algorithm to detect the intent or issue expressed by the user 112 in the response 502. As noted above, the bot switch algorithm includes an NLU engine that is dynamically trained to match or approximate a user's exchanged communication against a set of phrases, utterances, and/or knowledge base articles. Accordingly, the bot switch algorithm may determine, in real-time or near real-time for the response 502, a confidence score or threshold value corresponding to the likelihood of a particular intent being present in the response 502. For instance, the NLU engine may dynamically calculate a confidence score or threshold value for each possible intent (subject to an intent domain defined by the brand or otherwise detected by the brand platform service, as described above) to determine the approximate level of confidence in matching the response 502 to these possible intents. The NLU engine may be configured to implement a threshold limit whereby any intent not having a corresponding confidence score or threshold value that exceeds this threshold limit may be classified as not being associated with the response 502. If a particular intent has a corresponding confidence score or threshold value that exceeds this threshold limit, the NLU engine may automatically determine that the particular intent is likely present in the response 502.

Returning to the illustrative example illustrated in FIG. 5A, the NLU engine implemented by the automated bot 108-1 may detect that the user's particular intent corresponds to a desire to check their savings account balance (e.g., “Intent=Savings”). For instance, the NLU engine may determine, in real-time or near real-time for the response 502, a confidence score or threshold value corresponding to the likelihood of a particular intent being present in the response 502. As illustrated in FIG. 5A, the automated bot 108-1, through the NLU engine, has determined that the intent “Savings” is likely present in the response 502 based on the confidence score or threshold value corresponding to the intent and for the response 502. In response to determining that the current intent associated with the communications session 114 is “Savings,” the automated bot 108-1 may determine whether it is associated with the “Savings” intent and, if not, identify the appropriate automated bot to which the communications session 114 may be transferred to for addressing the “Savings” intent.

In some instances, if the automated bot 108-1 determines that it is not associated with the detected intent and is unable to identify another automated bot within the bot group 106 that is associated with the detected intent, the automated bot 108-1 may automatically transmit, through the communications session, a fallback message. The fallback message may indicate that the identified intent cannot be resolved through the communications session 114. In some instances, the fallback message may provide the user 112 with information (e.g., electronic mail address, telephone number, etc.) for contacting a live agent (i.e., a human agent that may be knowledgeable with regard to one or more intents or other issues that the user 112 may wish to have resolved) that may be able to address the user's intent. In an embodiment, if the automated bot 108-1 is unable to identify an automated bot within the bot group 106 that is associated with the detected intent, the automated bot 108-1 can automatically transfer the communications session 114 to a live agent associated with the brand.

As illustrated in FIG. 5B, the automated bot 108-1 has determined that it is not associated with the “Savings” intent and that, instead, automated bot 108-2 within the bot group 106 is known to be associated with the “Savings” intent. Accordingly, the automated bot 108-1 may automatically, and in real-time or near real-time, transfer the ongoing communications session 114 to the automated bot 108-2. The automated bot 108-1, for instance, may transmit a signal or other executable instruction to the automated bot 108-2 to engage the user 112 in the communications session 114. Additionally, the automated bot 108-1 may automatically pass any previously obtained contextual information to the automated bot 108-2. In some instances, the contextual information may be associated with different intents. Accordingly, the automated bot 108-2 may identify, from the provided contextual information, any contextual information corresponding to the intent associated with the automated bot 108-2. If no contextual information is available that is associated with the identified intent, the automated bot 108-2 may automatically rely on the most recent user communication (e.g., response 502) to automatically determine an appropriate communication that is responsive to this user communication. Once the automated bot 108-1 has provided this contextual information and receives acknowledgement that automated bot 108-2 is engaged in the communications session 114, the automated bot 108-1 may disengage from the communications session 114 and terminate.

The automated bot 108-2, upon joining the communications session 114, may prompt the user 112 (such as through intent communication 504 illustrated in FIG. 5B) to provide their savings account number. Additionally, the automated bot 108-2 may query the contextual state module 206 to obtain any available contextual information associated with the user 112 and/or the communications session 114. In response to the query from the automated bot 108-2, the contextual state module 206 may provide the automated bot 108-2 with any available contextual information associated with the user 112. The contextual state module 206 may use any provided identifying information associated with the user 112 to query the myriad key-value entries maintained by the contextual state module 206 to identify any entries that include properties associated with the provided identifying information. Accordingly, the contextual state module 206 may provide these identified entries to the automated bot 108-2.

The automated bot 108-2 may not be required to again greet the user 112 through the communications session 114, as the user 112 was already greeted by automated bot 108-1. Further, the automated bot 108-2 may not be required to prompt the user 112 for any previously provided identifying information garnered by the automated bot 108-1 and/or the brand platform service when facilitating the communications session 114, as this contextual information is automatically obtained from the contextual state module 206 when joining the communications session 114. Thus, the user 112 may not need to be prompted again for any previously provided information, thereby avoiding repetitious queries and potential sources of user frustration.

As illustrated in FIG. 5C, in response to the intent communication 504, the user 112 may provide a new response 506 that includes new contextual information associated with the user 112 (e.g., the savings account number “801210-410”). The automated bot 108-2 may use this response to perform one or more actions that may resolve the user's indicated intent or issue. For example, using the provided savings account number, the automated bot 108-2 may access the user's savings account and provide a response through the communications session 114 that indicates the account balance associated with this savings account.

As the new response 506 includes new contextual information associated with the user 112, the contextual state module 206, through an NLP algorithm, may process the new response 506 and generate a new key-value pair that includes the provided account number in association with a namespace corresponding to account numbers. For instance, the contextual state module 206, through the NLP algorithm, may identify the namespace for the contextual information (e.g., “ACCOUNT NUMBER,” etc.), a property that may uniquely associate the key-value pair with the user 112 (e.g., username, communications session identifier, timestamp corresponding to the communications session, etc.), and the corresponding value (e.g., “801210-410,” any other account number information provided by the user 112, etc.). In some instances, when the user 112 provides the requested contextual information, the automated bot 108-2 may transmit an API call to the contextual state module 206 to define the new key-value pair for the received contextual information.

In an embodiment, as the automated bot 108-2 communicates with the user 112 through the communications session 114, the automated bot 108-2 (through its version of the NLU engine) may continue to process any communications exchanged between the user 112 and the automated bot 108-2 through the communications session 114 to determine the current intent associated with the communications session 114. If the automated bot 108-2 determines that the intent has changed, the automated bot 108-2, through the NLU engine, may determine whether the automated bot 108-2 is associated with this new intent. If the automated bot 108-2 is associated with this new intent, the automated bot 108-2 may continue to engage the user 112 through the communications session 114 and perform any required actions associated with this new intent (e.g., prompt the user 112 for new contextual information associated with the new intent, utilize relevant contextual information to perform any actions needed to address the new intent, etc.). Alternatively, if the automated bot 108-2 determines that it is not capable of addressing the new intent, the automated bot 108-2 may evaluate the bot group 106 to determine whether there is another automated bot within the bot group 106 that is associated with the new intent. If there are no other automated bots within the bot group 106 that are associated with this new intent, the automated bot 108-2 may transmit a fallback message to the user 112.

In some instances, the communications session 114 may be monitored in real-time or near real-time by an auditing entity (e.g., an auditing system associated with the brand platform service, the brand, etc.) to continuously obtain feedback corresponding to the performance of the automated bots engaged with the user 112 in the communications session 114. For instance, if a user expresses that an automated bot is not providing relevant responses to the user's communicated intent or other issue, the auditing entity may determine that the NLU engine associated with the automated bot has failed to properly determine the intent communicated by the user. Alternatively, if the NLU engine associated with the automated bot correctly identified the intent communicated by the user but the automated bot failed to transfer the communications session to the appropriate automated bot, the auditing entity may determine that the automated bot requires retraining. These communications may be annotated to indicate the correct intent associated with the communications and to indicate which automated bot from the bot group 106 the communications session should have been transferred to for this intent.

In some instances, based on the obtained feedback, the auditing entity may determine whether the intent classifications defined by the different versions of the NLU engine are resulting in intent classification confusion. Accordingly, the exchanged communications in the dataset used to train the NLU engine may be annotated to indicate the correct intent classifications. As another illustrative example of possible feedback that may be used to retrain the NLU engine and improve the performance of the automated bots within the bot group 106, if an automated bot erroneously transferred a communications session to another automated bot based on an identified intent, and the other automated bot was subsequently unable to address the particular intent during the communications session 114, the communications exchanged during the communications session 114 may be evaluated to determine the appropriate intent communicated by the user 112 and the appropriate automated bot from the bot group 106 (if any) to which the communications session 114 should have been transferred to. This feedback may be obtained in real-time as communications are exchanged between the user 112 and one or more automated bots from the bot group 106. Additionally, or alternatively, the feedback may be obtained at the conclusion of the communications session 114.

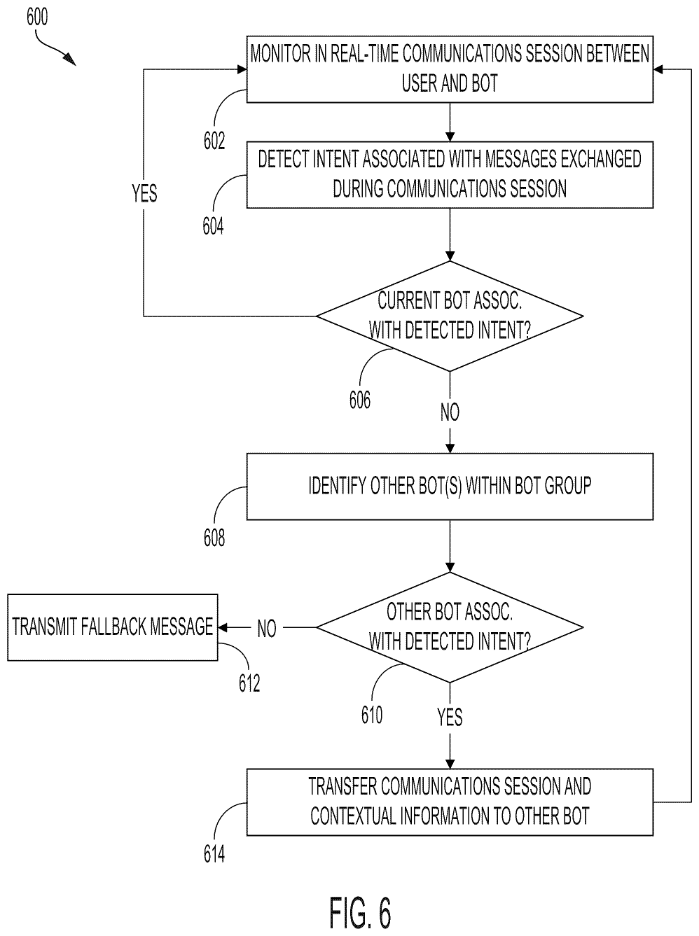

FIG. 6 shows an illustrative example of a process 600 for transferring a communications session from a first bot within a bot group to a second bot within the bot group based on a detected intent in accordance with at least one embodiment. The process 600 may be performed by a bot orchestrator implemented by a brand platform service. As noted above, the bot orchestrator may be implemented to dynamically process, for each ongoing communications session, communications exchanged between users and different automated bots associated with a bot group to determine whether to transfer the ongoing communications session from one automated bot to another automated bot within the bot group. In some instances, a unique bot orchestrator may be implemented for each bot group such that the bot orchestrator may only process communications associated with ongoing communications sessions including automated bots from the designated bot group. In such instances, when a brand provisions a new bot group for a particular function or environment, the brand platform service may provision a new bot orchestrator for this new bot group.

At step 602, the bot orchestrator may monitor, in real-time or near real-time, communications between a user and an automated bot during an ongoing communications session and as these communications are exchanged. For instance, if the brand platform service implements a user messaging system through which the ongoing communications session is facilitated, the user messaging system may maintain, for the ongoing communications session, a data stream through which communications exchanged through the ongoing communications session are automatically transmitted to the bot orchestrator in real-time or near real-time. Alternatively, the bot orchestrator may be configured to automatically, and in real-time or near real-time, pull from the ongoing communications sessions any communications exchanged between a user and an automated as these communications are exchanged.

At step 604, the bot orchestrator may automatically detect the intent associated with the received communications (i.e., messages) exchanged during the communications session. As noted above, the bot orchestrator may implement a bot switch algorithm or NLU engine that is dynamically trained to match or approximate a user's exchanged communication against a set of phrases, utterances, and/or knowledge base articles. Through this bot switch algorithm or NLU engine, the bot orchestrator may determine a confidence score or threshold value for each possible intent corresponding to the bot group (as defined through an intent domain for the bot group) associated with the ongoing communications session. Any intent that has a corresponding confidence score or threshold value that does not exceed a pre-defined threshold limit may be considered to not be present within the received communications. Alternatively, an intent having a corresponding confidence score or threshold value that exceeds a pre-defined threshold limit may be classified as likely to be present within the received communications. In an embodiment, if multiple intent matches are found (i.e., the confidences scores or threshold values for multiple intents exceed the pre-defined threshold limit), the bot orchestrator can select the intent having the highest confidence score or threshold value. If these multiple intents have the same confidence score or threshold value, the bot orchestrator may select a particular intent at random from these multiple intents.

At step 606, the bot orchestrator may determine whether the current automated bot engaged with the user in the communications session is associated with the identified intent. As noted above, the bot switch algorithm implemented by the bot orchestrator may be dynamically trained in real-time to associate different intents with different automated bots within a bot group based on communications exchanged between users and these different automated bots during different communications sessions. Accordingly, based on the identified intent, the bot orchestrator may identify any intents that are associated with the current automated bot. If the bot orchestrator determines that the current automated bot is associated with the identified intent, the bot orchestrator may continue to monitor the ongoing communications session to detect any changes to the intent associated with newly exchanged communications, thereby restarting the process 600.

If the bot orchestrator determines that the current automated bot engaged in the communications is not associated with the identified intent, the bot orchestrator, at step 608, may identify any other automated bots within the bot group and, at step 610, determine whether there is another automated bot within the bot group that is associated with the identified intent. For instance, the bot orchestrator may evaluate the intent domain associated with the bot group and the intent assignments generated by the bot switch algorithm for the set of automated bots within the bot group to determine whether a particular automated bot within the bot group has been assigned to the identified intent.

If the bot orchestrator is unable to identify an automated bot within the bot group that is capable of addressing the identified intent, the bot orchestrator, at step 612, may transmit a fallback message to the user (such as through the communications session). The fallback message may indicate that the identified intent cannot be resolved through the communications session. In some instances, the fallback message may provide the user with information (e.g., electronic mail address, telephone number, etc.) for contacting a live agent (i.e., a human agent that may be knowledgeable with regard to one or more intents or other issues that users may wish to have resolved) that may be able to address the user's intent. In some instances, if the bot orchestrator is unable to identify an automated bot that is associated with the identified intent, the bot orchestrator may automatically transfer the communications to a live agent associated with the brand. In an embodiment, the bot orchestrator can automatically terminate the ongoing communications session once the fallback message has been transmitted to the user.

If the bot orchestrator successfully identifies another automated bot from the bot group that is associated with the identified intent, the bot orchestrator, at step 614, may transfer the communications session from the current automated bot to the identified automated bot associated with the identified intent. For instance, the bot orchestrator may transmit executable instructions to the current automated bot to automatically transfer the communications session to the identified automated bot within the bot group. Alternatively, the bot orchestrator may transmit an executable instruction or command to the current automated bot to disengage from the communications session. If the bot orchestrator causes the current automated bot to disengage from the communications session, the bot orchestrator may access the bot group to execute the identified automated bot associated with the identified intent. Execution of the identified automated bot may cause the identified automated bot to automatically join the communications session and engage the user.

As noted above, any contextual information associated with the user and/or the ongoing communications session may be automatically obtained by an automated bot when the automated bot joins the ongoing communications session. For instance, the automated bot, upon joining the communications session, may query a contextual state module to obtain any available contextual information associated with the user and/or the communications session. In response to the query from the automated bot, the contextual state module may provide the automated bot with any available contextual information associated with the user. In some instances, when the communications session is transferred from the current automated bot to the identified automated bot, the current automated bot may automatically pass any previously obtained contextual information to the identified automated bot. In some instances, the contextual information may be associated with different intents. Accordingly, the automated bot joining the communications session may identify, from the provided contextual information, any contextual information corresponding to the identified intent. If no contextual information is available that is associated with the identified intent, the automated bot may automatically rely on the most recent user communication to automatically determine an appropriate communication that is responsive to this user communication.

As noted above, the bot orchestrator may continuously process communications exchanged between a user and one or more automated bots associated with a bot group to detect any changes to the current intent and, accordingly, transfer the communications session to corresponding automated bots. Thus, once the communications session has been transferred to the identified automated bot, the bot orchestrator, at step 602, may monitor in real-time or near real-time the communications session between the user and the identified automated bot, thereby restarting the process 600.

It should be noted that the process 600 may include additional and/or alternative steps not illustrated in FIG. 6. For example, the communications exchanged during the communications session can be evaluated (in real-time and/or at the conclusion of the communications session) to obtain any feedback that may be used to update the bot switch algorithm implemented by the bot orchestrator. For instance, if the bot switch algorithm erroneously assigned a particular intent to an automated bot, and the automated bot was subsequently unable to address the particular intent during the communications session, the communications exchanged during the communications session may be evaluated to determine the actual intent associated with these communications and the automated bot (if any) to which the communications session should have been transferred to. Through this evaluation, the corresponding communications may be annotated and added to the dataset used to dynamically train the bot switch algorithm. Thus, the bot orchestrator may further monitor the communications exchanged during the communications session to automatically obtain the user's feedback with regard to the communications session and the corresponding automated bots engaged in the communications session.

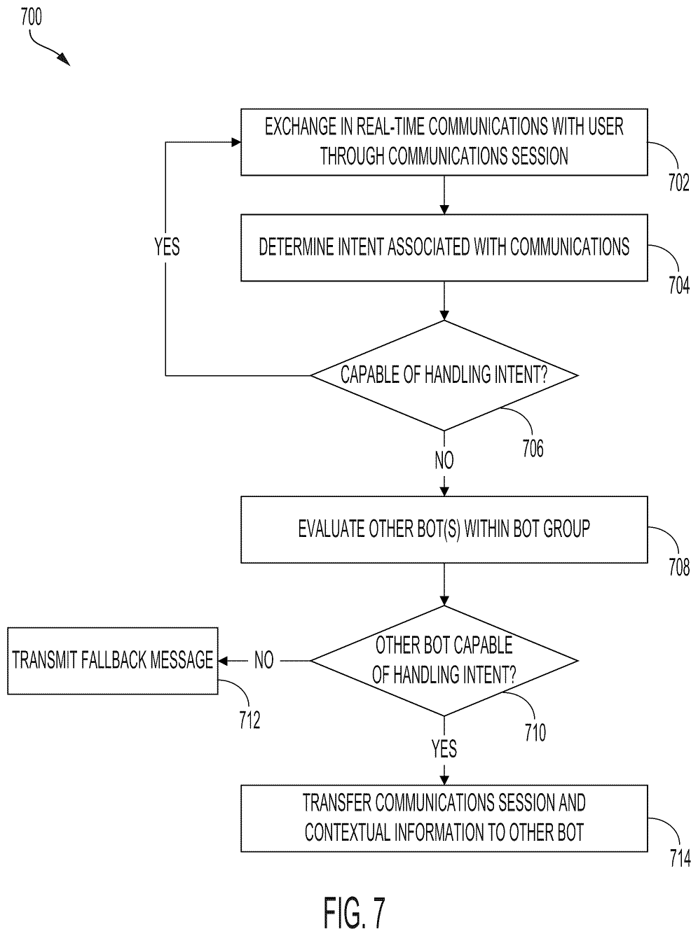

FIG. 7 shows an illustrative example of a process 700 for transferring a communication session to another bot within a bot group upon detection of an intent associated with the other bot in accordance with at least one embodiment. As noted above, in some instances, the brand platform service may implement a bot switch algorithm without a bot orchestrator. In such instances, each automated bot within a bot group may implement a version of the bot switch algorithm to dynamically, and in real-time, detect a user's communicated intent as communications are exchanged between the user and the automated bot and, accordingly, make bot switch determinations according to this communicated intent. Thus, the process 700 may be performed by an automated bot engaged with a user through an ongoing communications session. Further, certain steps associated with the process 700 may be performed by the version of the bot switch algorithm or NLU engine implemented by the automated bot.

At step 702, the automated bot may exchange, in real-time or near real-time, communications with a user through an ongoing communications session. In some examples, this automated bot may be engaged in the communications session when the communications session is initiated by the brand platform service. Accordingly, this automated bot may be configured to greet the user and, additionally, prompt the user to indicate their intent or issue that the user would like to have resolved. Alternatively, the automated bot may be added to the communications session as a result of the automated bot being associated with a previously identified intent communicated by the user during the communications session.

As these communications are exchanged between the automated bot and the user, the automated bot, at step 704, may determine the current intent associated with these communications. For instance, the automated bot may dynamically process these communications through a bot switch algorithm to detect the intent or issue expressed by the user in these communications. The bot switch algorithm, as noted above, may include an NLU engine that is dynamically trained to match or approximate a user's exchanged communication against a set of phrases, utterances, and/or knowledge base articles. Accordingly, the bot switch algorithm may determine, in real-time or near real-time for the exchanged communications, a confidence score or threshold value corresponding to the likelihood of a particular intent being present in these communications. For instance, the NLU engine may dynamically calculate a confidence score or threshold value for each possible intent (subject to an intent domain defined by the brand or otherwise detected by the brand platform service, as described above) to determine the approximate level of confidence in matching the exchanged communications to these possible intents. Any intent not having a confidence score or threshold value that exceeds a pre-defined threshold limit may be classified as not being associated with the exchanged communications. If a particular intent has a corresponding confidence score or threshold value that exceeds this threshold limit, the NLU engine may automatically determine that the particular intent is likely present in these communications. Thus, through this scoring process, the automated bot may identify an intent associated with the exchanged communications.

At step 706, the automated bot may determine whether it is capable of handling the identified intent. As noted above, each automated bot within a bot group may be associated with particular intents that the automated bot is configured to address on behalf of a brand. These associations between automated bots and intents may be defined by a brand through an intent domain, as described above. If the automated bot determines that it is capable of handling the identified intent (e.g., the automated bot is associated with the identified intent, etc.), the automated bot may continue to exchange, in real-time or near real-time, communications with the user through the communications session, thereby restarting the process 700.

If the automated bot determines that it is not capable of handling the identified intent (e.g., the automated bot is not associated with the identified intent, etc.), the automated bot, at step 708, may evaluate the other automated bots within the bot group to determine, at step 710, whether there is another automated bot in the bot group that is capable of handling the identified intent. Similar to the process 600 described above in connection with FIG. 6, the automated bot may evaluate the intent domain associated with the bot group and the intent assignments for the set of automated bots within the bot group to determine whether a particular automated bot within the bot group has been assigned to the identified intent.

If the automated bot determines that it is not associated with the identified intent and is unable to identify another automated bot within the bot group that is associated with the identified intent, the automated bot, at step 712, may automatically transmit, through the communications session, a fallback message. The fallback message may indicate that the identified intent cannot be resolved through the communications session. In some instances, the fallback message may provide the user with information (e.g., electronic mail address, telephone number, etc.) for contacting a live agent (i.e., a human agent that may be knowledgeable with regard to one or more intents or other issues that the user may wish to have resolved) that may be able to address the user's intent. In an embodiment, if the automated bot is unable to identify an automated bot within the bot group that is associated with the identified intent, the automated bot can automatically transfer the communications session to a live agent associated with the brand. In some instances, once the fallback message has been transmitted to the user through the communications session, the automated bot may terminate the communications session.

If the automated bot identifies another automated bot within the bot group that is capable of handling the identified intent, the automated bot, at step 714, may automatically transfer the communications session to this other automated bot. The automated bot, for instance, may transmit a signal or other executable instruction to the identified automated bot to engage the user in the communications session. Additionally, the automated bot may automatically pass any previously obtained contextual information to the identified automated bot. In some examples, the automated bot may not be required to pass any previously obtained contextual information. Accordingly, the identified automated bot, upon joining the communications session, may query the contextual state module (as described above) to obtain any available contextual information associated with the user and the ongoing communications session. Further, the identified automated bot, upon joining the communications, may execute the process 700 such that, if a new intent is detected, the identified automated bot may determine whether it is capable of handling this new intent and, if not, transfer the communications session to another automated bot (if available) within the bot group capable of handling the new intent.

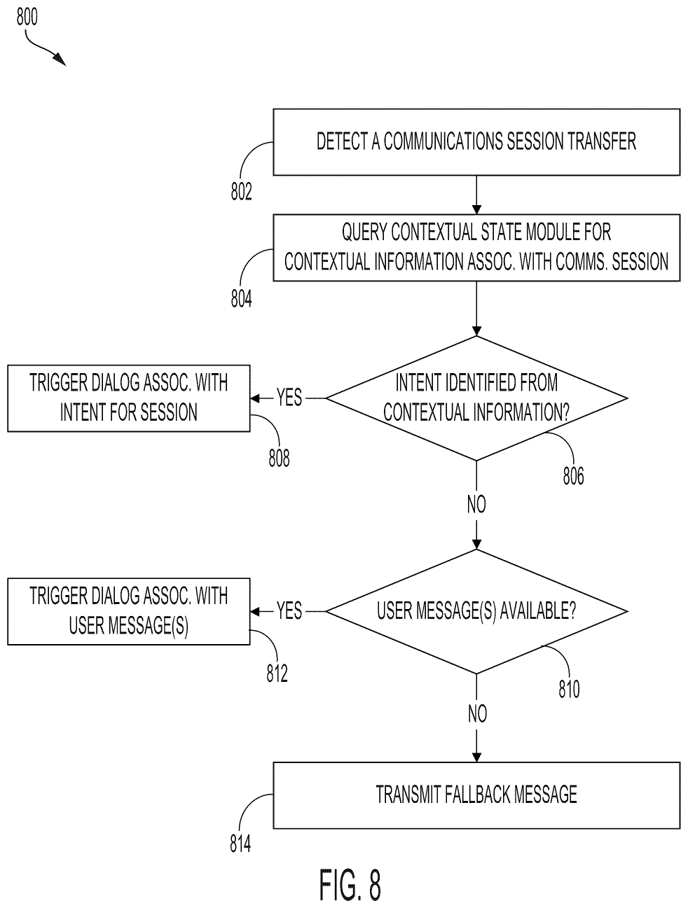

FIG. 8 shows an illustrative example of a process 800 for obtaining contextual information associated with a transferred communications session to identify information previously shared by a user engaged in the communications session in accordance with at least one embodiment. The process 800 may be performed by any automated bot associated with a bot group and that has been added to an ongoing communications session. As noted above, when an automated bot joins an ongoing communications session, the automated bot may automatically obtain any contextual information that may be associated with the user engaged in the communications session and with the communications session itself. This may obviate the need of the automated bot to again prompt the user for contextual information that the user may have previously provided to another automated bot during the ongoing communications session or during a previous communications session (subject to an expiration or “time to live” for the contextual information).

At step 802, an automated bot may detect a communications session transfer whereby the automated bot has been added to the communications session. As noted above, a bot orchestrator or another automated bot engaged in the communications session may process, in real-time, communications exchanged through an ongoing communications session to determine the intent associated with these communications. If the automated bot engaged with the user in the communications session is not capable of handling this identified intent, the bot orchestrator or this automated bot may determine whether there is an automated bot within the bot group that is capable of handling this intent (e.g., the automated bot is assigned to the intent by the brand or by a bot switch algorithm, as described above). If there is an automated bot within the bot group that is capable of handling the identified intent, the bot orchestrator or the current automated bot engaged in the ongoing communications session may automatically transfer the communications session to the identified automated bot.

At step 804, once the automated bot has joined the communications session, the automated bot may query the contextual state module for any available contextual information associated with the user and/or the communications session. For instance, the automated bot may transmit an API call to the contextual state module to retrieve the required contextual information from the key-value datastore. The API call may include a GET command that indicates the name of the namespace (e.g., the type of contextual information being requested) and any properties that may be used to identify the appropriate key-value pair that includes the required contextual information. The properties may include unique information associated with the user and/or the communications session (e.g., username, unique identifier for the communications session, timestamp corresponding to the time at which the communications session was initiated, etc.). In response to the API call, the contextual state module may query the various key-value entries to identify any entries that satisfy the elements of the request.

At step 806, the automated bot may determine whether the available contextual information contains an intent that the automated bot is to address or resolve through the ongoing communications session. As noted above, in response to the API call from the automated bot, the contextual state module may query the key-value datastore to identify any entries that satisfy the elements of the automated bot's request. Accordingly, the contextual information module may return the requested contextual information to the automated bot. In some instances, the API call may include a generic GET command that does not make reference to specific namespaces or properties. In response to the generic GET command, the contextual state module may return any available contextual information associated with the ongoing communications session and the user.

If the automated bot obtains contextual information associated with the identified intent, the automated bot, at step 808, may trigger dialog associated with the intent for the ongoing communications session. For instance, the automated bot may perform any actions associated with the identified intent and using the obtained contextual information. As an illustrative example, if the contextual information includes the user's savings account number and an indication that the user is requesting the present balance associated with their savings account, the automated bot may automatically use the savings account number to access the savings account, determine the present balance associated with this account, and communicate the present balance to the user through the ongoing communications session. Thus, the automated bot may not need to prompt the user, through the ongoing communications session, to again provide their savings account number.

If the automated bot determines that that the required contextual information is not available (e.g., the contextual state module does not maintain an entry including the contextual information associated with the identified intent, etc.), the automated bot, at step 810, may determine whether there are any user messages available that may be used to determine what action(s) the automated bot is to perform. For instance, the automated bot may automatically process the communications exchanged by the user during the ongoing communications session to identify the intent associated with these communications. Accordingly, based on this identified intent and the corresponding communications, the automated bot, at step 812, may trigger dialog associated with the identified intent and corresponding communications. Returning to an earlier example, if the automated bot requires the user's account number in order to provide a response to the user's query for their account balance, and the contextual state module does not maintain a key-value entry corresponding to the user's account number, the automated bot may prompt the user to provide their account number.

If the automated bot is unable to determine the user's intent and is unable to obtain any user messages that can be used to identify what actions may be performed, the automated bot, at step 814, may transmit a fallback message to the user through the ongoing communications session. As noted above, the fallback message may indicate that the automated bot cannot resolve the user's intent or issue through the communications session. Similar to the fallback message described above in connection with FIG. 7, the fallback message may provide the user with information for contacting a live agent that may be able to address the user's intent. In an embodiment, the automated bot can automatically transfer the communications session to a live agent associated with the brand. In some instances, once the fallback message has been transmitted to the user through the communications session, the automated bot may terminate the communications session.

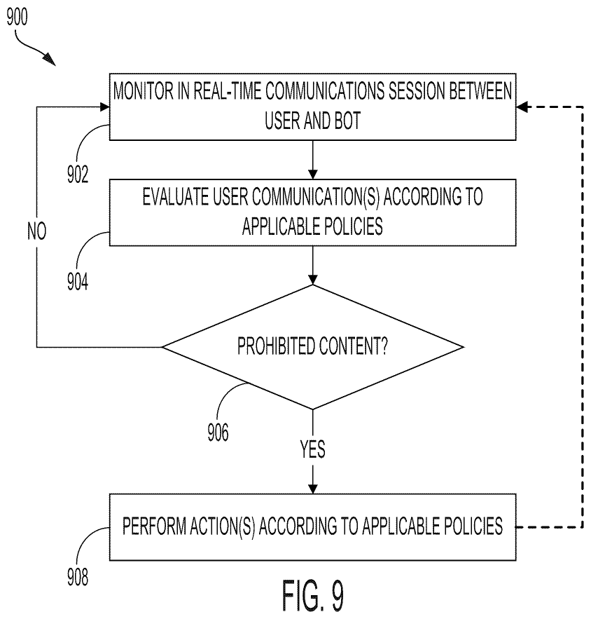

FIG. 9 shows an illustrative example of a process 900 for performing one or more actions according to applicable policies and in response to detection of a prohibited communication exchanged during a communications session between a user and a bot in accordance with at least one embodiment. The process 900 may be performed by a bot orchestrator implemented by a brand platform service. As noted above, the bot orchestrator may be implemented to dynamically process, for each ongoing communications session, communications exchanged between users and different automated bots associated with a bot group according to any applicable communications session policies. These applicable communications session policies may be further applied by unique bot orchestrators implemented for each bot group, whereby a unique bot orchestrator may only monitor, according to the applicable policies, communications associated with ongoing communications sessions including automated bots from the designated bot group.

At step 902, the bot orchestrator may monitor, in real-time or near real-time, communications between a user and an automated bot during an ongoing communications session and as these communications are exchanged. For instance, if the brand platform service implements a user messaging system through which the ongoing communications session is facilitated, the user messaging system may maintain, for the ongoing communications session, a data stream through which communications exchanged through the ongoing communications session are automatically transmitted to the bot orchestrator in real-time or near real-time. Alternatively, the bot orchestrator may be configured to automatically, and in real-time or near real-time, pull from the ongoing communications sessions any communications exchanged between a user and an automated as these communications are exchanged.

At step 904, the bot orchestrator may evaluate the exchanged communications, in real-time or near real-time, according to any applicable policies implemented by a brand and/or the brand platform service. In an embodiment, the bot orchestrator may implement an NLP algorithm or other machine learning algorithm/artificial intelligence that is dynamically trained to process, in real-time or near real-time, communications exchanged between users and automated bots as these communications are exchanged according to any applicable policies implemented by the brand and/or the brand platform service. The NLP algorithm implemented by the bot orchestrator may be dynamically trained using a dataset of sample communications (e.g., historical communications between actual users and automated bots, hypothetical or artificial communications between hypothetical users and automated bots, etc.), sample policies, and known prohibited content includes in the sample communications. This may allow for evaluation of the NLP algorithm to determine whether the NLP algorithm is correctly detecting, according to the applicable sample policies, the prohibited content from the supplied sample communications. If there are any errors detected in the identification of prohibited content from the sample communications, the NLP algorithm may be retrained to improve the likelihood of the NLP algorithm correctly detecting the prohibited content.

As noted above, a policy that is applicable to communications sessions between users and automated bots may define what content is prohibited or otherwise impermissible from users engaged in these communications sessions. For instance, a brand or the brand platform service may define a policy whereby the use of profanity within a communications session is prohibited. The policy may indicate which terms are to be considered profanity for the purpose of identifying prohibited content within a communications session. Additionally, or alternatively, the policy may provide a network address corresponding to a database of known profane terms that are to be considered prohibited for the applicable communications sessions. It should be noted that while profane terms are used extensively for the purpose of illustrating possible prohibited content, a brand and/or the brand platform service may define additional and/or alternative content that may be deemed prohibited within a communications session. For example, prohibited content may include threats, content that is sexual in nature, content corresponding to competitors, content corresponding to illegal activity, and the like.

At step 906, the bot orchestrator may determine whether an exchanged communication includes content that is prohibited according to one or more applicable policies. For instance, the bot orchestrator, through the aforementioned NLP algorithm or other machine learning algorithm/artificial intelligence, may automatically and in real-time or near-time, process an exchanged communication according to the applicable policies to determine whether the exchanged communication includes any content deemed to be prohibited by virtue of the applicable policies. This processing of the exchanged communication may be performed in real-time or near real-time as the communication is exchanged between the user and the automated bot engaged in the communications session. If the bot orchestrator determines that the exchanged communication does not violate the applicable policies (e.g., the exchanged communication does not include any prohibited content, etc.), the bot orchestrator may continue to monitor, in real-time or near real-time, the communications exchanged between the user and the automated bot as these communications are exchanged.

If the bot orchestrator detects, from an exchanged communication, any prohibited content in violation of any of the applicable policies, the bot orchestrator may perform, at step 908, one or more actions according to the applicable policies that were violated. As noted above, an applicable policy may provide executable instructions that may be automatically executed by the bot orchestrator when prohibited content is detected within an active communications session. Accordingly, the bot orchestrator may automatically execute the executable instructions included in the policy to address this violation of the applicable policy. As an illustrative example, if a user has included prohibited content in a communication exchanged in the communications session, the bot orchestrator may automatically transmit a notification to the user through the communications session to cease transmission of prohibited content during the communications session. As another example, the bot orchestrator may mute or otherwise restrict the user's ability to exchange communications through the communications session for a pre-defined period of time (e.g., one minute, five minutes, etc.). In some instances, the bot orchestrator may automatically terminate the communications session in response to detecting the prohibited content.

In an embodiment, depending on the one or more actions taken in response to the prohibited content, the bot orchestrator can continue to monitor the communications session between the user and the automated bot, thereby restarting the process 900. For example, if the bot orchestrator provides a warning to the user with regard to exchanged prohibited content, the bot orchestrator may continue to monitor the user's communications exchanged during the communications session to detect any recurrence of the user's violation of the applicable policies. The repeated violation of the applicable policies may result in different actions performed by the bot orchestrator. For example, if a user was initially provided with a warning in response to exchanging prohibited content and the bot orchestrator determines that the user has subsequently exchanged additional prohibited content in violation of the applicable policies, the bot orchestrator may mute the user, restrict the user's ability to exchange further communications through the communications session, or terminate the communications session. In some instances, if the bot orchestrator terminates the communications session in response to the user's prohibited content, the process 900 may end without continuing to monitor the communications session.

In an embodiment, feedback corresponding to the automatic identification of prohibited content (or lack thereof) may be used to dynamically update the NLP algorithm or other machine learning algorithm/artificial intelligence in real-time or near real-time as communications are exchanged between users and automated bots through different ongoing communications sessions. For instance, the bot orchestrator or other evaluator of the NLP algorithm or other machine learning algorithm/artificial intelligence may evaluate a transcript or other record of a completed communications session to determine whether any prohibited content was exchanged during the communications session and, if so, whether any appropriate actions were performed to address this exchange of prohibited content. If the bot orchestrator or other evaluator determines that the NLP algorithm or other machine learning algorithm/artificial intelligence has failed to detect the prohibited content exchanged during the communications session, the bot orchestrator or other evaluator may retrain the NLP algorithm or other machine learning algorithm/artificial intelligence to increase the likelihood of the NLP algorithm or other machine learning algorithm/artificial intelligence in identifying prohibited content. For instance, the bot orchestrator or other evaluator may annotate the communication including the identified prohibited content and add this annotated communication to the dataset used to train the NLP algorithm or other machine learning algorithm/artificial intelligence. This may allow for continued training of the NLP algorithm or other machine learning algorithm/artificial intelligence as new communications are exchanged between users and automated bots during different communications sessions.

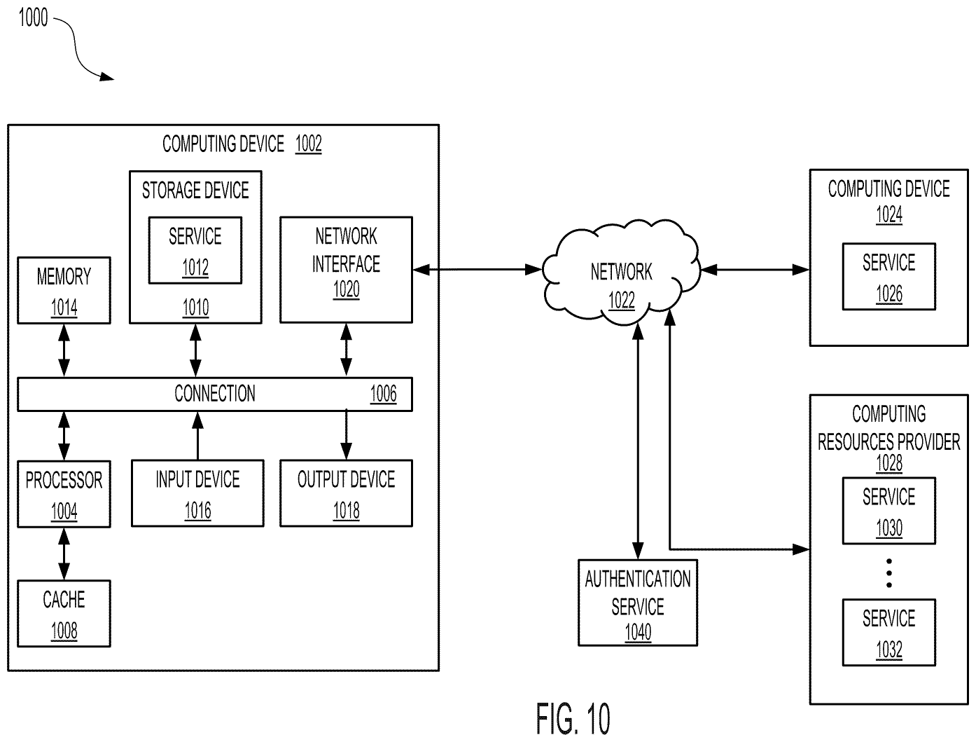

FIG. 10 illustrates a computing system architecture 1000, including various components in electrical communication with each other, in accordance with some embodiments. The example computing system architecture 1000 illustrated in FIG. 10 includes a computing device 1002, which has various components in electrical communication with each other using a connection 1006, such as a bus, in accordance with some implementations. The example computing system architecture 1000 includes a processing unit 1004 that is in electrical communication with various system components, using the connection 1006, and including the system memory 1014. In some embodiments, the system memory 1014 includes read-only memory (ROM), random-access memory (RAM), and other such memory technologies including, but not limited to, those described herein. In some embodiments, the example computing system architecture 1000 includes a cache 1008 of high-speed memory connected directly with, in close proximity to, or integrated as part of the processor 1004. The system architecture 1000 can copy data from the memory 1014 and/or the storage device 1010 to the cache 1008 for quick access by the processor 1004. In this way, the cache 1008 can provide a performance boost that decreases or eliminates processor delays in the processor 1004 due to waiting for data. Using modules, methods and services such as those described herein, the processor 1004 can be configured to perform various actions. In some embodiments, the cache 1008 may include multiple types of cache including, for example, level one (L1) and level two (L2) cache. The memory 1014 may be referred to herein as system memory or computer system memory. The memory 1014 may include, at various times, elements of an operating system, one or more applications, data associated with the operating system or the one or more applications, or other such data associated with the computing device 1002.

Other system memory 1014 can be available for use as well. The memory 1014 can include multiple different types of memory with different performance characteristics. The processor 1004 can include any general purpose processor and one or more hardware or software services, such as service 1012 stored in storage device 1010, configured to control the processor 1004 as well as a special-purpose processor where software instructions are incorporated into the actual processor design. The processor 1004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1004 can be a microprocessor, a microcontroller, a digital signal processor (“DSP”), or a combination of these and/or other types of processors. In some embodiments, the processor 1004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1000, an input device 1016 can represent any number of input mechanisms, such as a microphone for speech, a touch-sensitive screen for gesture or graphical input, keyboard, mouse, motion input, pen, and other such input devices. An output device 1018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1000. In some embodiments, the input device 1016 and/or the output device 1018 can be coupled to the computing device 1002 using a remote connection device such as, for example, a communication interface such as the network interface 1020 described herein. In such embodiments, the communication interface can govern and manage the input and output received from the attached input device 1016 and/or output device 1018. As may be contemplated, there is no restriction on operating on any particular hardware arrangement and accordingly the basic features here may easily be substituted for other hardware, software, or firmware arrangements as they are developed.

In some embodiments, the storage device 1010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1010 can include hardware and/or software services such as service 1012 that can control or configure the processor 1004 to perform one or more functions including, but not limited to, the methods, processes, functions, systems, and services described herein in various embodiments. In some embodiments, the hardware or software services can be implemented as modules. As illustrated in example computing system architecture 1000, the storage device 1010 can be connected to other parts of the computing device 1002 using the system connection 1006. In an embodiment, a hardware service or hardware module such as service 1012, that performs a function can include a software component stored in a non-transitory computer-readable medium that, in connection with the necessary hardware components, such as the processor 1004, connection 1006, cache 1008, storage device 1010, memory 1014, input device 1016, output device 1018, and so forth, can carry out the functions such as those described herein.

The disclosed brand platform service, the systems of the brand platform service, and the systems and methods for dynamically, and in real-time, detecting intents associated with real-time communications exchanged between users and automated bots and automatically transferring, in response to the detected intents, the communications to other automated bots capable of handling these intents can be performed using a computing system such as the example computing system illustrated in FIG. 10, using one or more components of the example computing system architecture 1000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with an obtained invoice described herein by, for example, executing code using a processor such as processor 1004 wherein the code is stored in memory such as memory 1014 as described herein. One or more of a user device, a provider server or system, a database system, or other such devices, services, or systems may include some or all of the components of the computing system such as the example computing system illustrated in FIG. 10, using one or more components of the example computing system architecture 1000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1014 can be coupled to the processor 1004 by, for example, a connector such as connector 1006, or a bus. As used herein, a connector or bus such as connector 1006 is a communications system that transfers data between components within the computing device 1002 and may, in some embodiments, be used to transfer data between computing devices. The connector 1006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1014 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1014 can also include magnetic or optical data storage media including read-only (e.g., CD ROM and DVD ROM) or otherwise (e.g., CD or DVD). The memory can be local, remote, or distributed.

As described herein, the connector 1006 (or bus) can also couple the processor 1004 to the storage device 1010, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data.

Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1006 can also couple the processor 1004 to a network interface device such as the network interface 1020. The interface can include one or more of a modem or other such network interfaces including, but not limited to those described herein. It will be appreciated that the network interface 1020 may be considered to be part of the computing device 1002 or may be separate from the computing device 1002. The network interface 1020 can include one or more of an analog modem, Integrated Services Digital Network (ISDN) modem, cable modem, token ring interface, satellite transmission interface, or other interfaces for coupling a computer system to other computer systems. In some embodiments, the network interface 1020 can include one or more input and/or output (I/O) devices. The I/O devices can include, by way of example but not limitation, input devices such as input device 1016 and/or output devices such as output device 1018. For example, the network interface 1020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1002 can be connected to one or more additional computing devices such as computing device 1024 via a network 1022 using a connection such as the network interface 1020. In such embodiments, the computing device 1024 may execute one or more services 1026 to perform one or more functions under the control of, or on behalf of, programs and/or services operating on computing device 1002. In some embodiments, a computing device such as computing device 1024 may include one or more of the types of components as described in connection with computing device 1002 including, but not limited to, a processor such as processor 1004, a connection such as connection 1006, a cache such as cache 1008, a storage device such as storage device 1010, memory such as memory 1014, an input device such as input device 1016, and an output device such as output device 1018. In such embodiments, the computing device 1024 can carry out the functions such as those described herein in connection with computing device 1002. In some embodiments, the computing device 1002 can be connected to a plurality of computing devices such as computing device 1024, each of which may also be connected to a plurality of computing devices such as computing device 1024. Such an embodiment may be referred to herein as a distributed computing environment.

The network 1022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1022 can be wired connections, wireless connections, or combinations thereof. Communications via the network 1022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1022, within the computing device 1002, within the computing device 1024, or within the computing resources provider 1028 can include information, which also may be referred to herein as content. The information may include text, graphics, audio, video, haptics, and/or any other information that can be provided to a user of the computing device such as the computing device 1002. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1002 and presented to a user of the computing device 1002 using forms that are perceptible via sight, sound, smell, taste, touch, or other such mechanisms. In some embodiments, communications over the network 1022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1002 and/or the computing device 1024 can be connected to a computing resources provider 1028 via the network 1022 using a network interface such as those described herein (e.g. network interface 1020). In such embodiments, one or more systems (e.g., service 1030 and service 1032) hosted within the computing resources provider 1028 (also referred to herein as within “a computing resources provider environment”) may execute one or more services to perform one or more functions under the control of, or on behalf of, programs and/or services operating on computing device 1002 and/or computing device 1024. Systems such as service 1030 and service 1032 may include one or more computing devices such as those described herein to execute computer code to perform the one or more functions under the control of, or on behalf of, programs and/or services operating on computing device 1002 and/or computing device 1024.

For example, the computing resources provider 1028 may provide a service, operating on service 1030 to store data for the computing device 1002 when, for example, the amount of data that the computing device 1002 exceeds the capacity of storage device 1010. In another example, the computing resources provider 1028 may provide a service to first instantiate a virtual machine (VM) on service 1032, use that VM to access the data stored on service 1032, perform one or more operations on that data, and provide a result of those one or more operations to the computing device 1002. Such operations (e.g., data storage and VM instantiation) may be referred to herein as operating “in the cloud,” “within a cloud computing environment,” or “within a hosted virtual machine environment,” and the computing resources provider 1028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1030 and service 1032 may implement versions of various services (e.g., the service 1012 or the service 1026) on behalf of, or under the control of, computing device 1002 and/or computing device 1024. Such implemented versions of various services may involve one or more virtualization techniques so that, for example, it may appear to a user of computing device 1002 that the service 1012 is executing on the computing device 1002 when the service is executing on, for example, service 1030. As may also be contemplated, the various services operating within the computing resources provider 1028 environment may be distributed among various systems within the environment as well as partially distributed onto computing device 1024 and/or computing device 1002.

In an embodiment, the computing device 1002 can be connected to one or more additional computing devices and/or services such as an authentication service 1040 via the network 1022 and using a connection such as the network interface 1020. In an embodiment, the authentication service 1040 is executing as one or more services (e.g., the service 1030 and/or the service 1032) operating within the environment of the computing resources provider. As used herein, an authentication service 1040 is a service used by one or more entities (such as brands, the brand platform service, etc.) to authenticate users engaged in communications sessions with automated bots, live agents, and other entities. An authentication service may be a third-party service that provides secure and verified authorization.

In an embodiment, elements of the authentication service 1040 are running as an application or web service operating on a computing device such as the computing device 1002 described herein. In such an embodiment, the application or web service of the authentication service 1040 may be provided by a system (e.g., a bank, a transaction processing system, an inventory management system, or some other such system). In an embodiment, elements of the authentication service 1040 are running on an auxiliary device or system configured to execute tasks associated with the authentication service 1040. In an embodiment, elements of the authentication service 1040 are running on virtual device such as those described herein. Although not illustrated here, in an embodiment, the authentication service 1040 may be running on one or more of a plurality of devices that may be interconnected using a network such as the network 1022.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1002) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1002.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method comprising:
dynamically monitoring a communications session in real-time as communications are exchanged between a user and an automated bot, wherein the automated bot is associated with a bot group including a set of automated bots;
identifying an intent associated with the communications;
determining that the automated bot is incapable of providing responses corresponding to the intent associated with the communications;
training a machine learning algorithm in real-time to dynamically associate different automated bots with identified intents, wherein the machine learning algorithm is trained using a dataset of sample communications sessions, known intents, and automated bot responses corresponding to the known intents;
identifying an alternative automated bot capable of providing the responses corresponding to the intent, wherein the alternative automated bot is identified using the intent and the communications as input to the machine learning algorithm;
automatically transferring the communications session in real-time from the automated bot to the alternative automated bot; and
updating the machine learning algorithm according to feedback corresponding to new responses, wherein the new responses are generated by the alternative automated bot.

2. The computer-implemented method of claim 1, further comprising:
providing contextual information previously obtained through the communications exchanged between the user and the automated bot, wherein the contextual information is provided to prevent the alternative automated bot from submitting a repeated query for the contextual information.

3. The computer-implemented method of claim 1, further comprising:
identifying a new intent associated with the communications session, wherein the new intent is not associated with any automated bot within the set of automated bots; and
transmitting a fallback message through the communications session.

4. The computer-implemented method of claim 1, further comprising:
automatically detecting contextual information exchanged through the communications session; and
storing the contextual information, wherein when the contextual information is stored, the contextual information is available to the set of automated bots.

5. The computer-implemented method of claim 1, wherein the intent is identified as a result of the intent having a highest threshold value compared to other possible intents associated with the communications.

6. The computer-implemented method of claim 1, further comprising:
identifying a new intent associated with the communications session, wherein the new intent is not associated with any automated bot within the set of automated bots; and
transferring the communications session from the alternative automated bot to a live agent.

7. The computer-implemented method of claim 1, further comprising:
detecting a prohibited communication, wherein the prohibited communication is detected according to one or more policies; and
automatically transmitting a response message, wherein the response message is automatically transmitted without bot intervention.

8. A system, comprising:
one or more processors; and
memory storing thereon instructions that, as a result of being executed by the one or more processors, cause the system to:
dynamically monitor a communications session in real-time as communications are exchanged between a user and an automated bot, wherein the automated bot is associated with a bot group including a set of automated bots;
identify an intent associated with the communications;
determine that the automated bot is incapable of providing responses corresponding to the intent through the communications session;
train a machine learning algorithm in real-time to dynamically associate different automated bots with identified intents, wherein the machine learning algorithm is trained using a dataset of sample communications sessions, known intents, and automated bot responses corresponding to the known intents;
identify an alternative automated bot capable of providing the responses corresponding to the intent, wherein the alternative automated bot is identified from the set of automated bots through the machine learning algorithm;
automatically transfer the communications session in real-time from the automated bot to the alternative automated bot; and
update the machine learning algorithm according to feedback corresponding to new responses generated by the alternative automated bot for the intent.

9. The system of claim 8, wherein the instructions further cause the system to:
provide contextual information previously obtained through the communications exchanged between the user and the automated bot, wherein the contextual information is provided to prevent the alternative automated bot from submitting a repeated query for the contextual information.

10. The system of claim 8, wherein the instructions further cause the system to:
identify a new intent associated with the communications session, wherein the new intent is not associated with any automated bot within the set of automated bots; and
transmit a fallback message through the communications session.

11. The system of claim 8, wherein the instructions further cause the system to:
automatically detect contextual information exchanged through the communications session; and
store the contextual information, wherein when the contextual information is stored, the contextual information is available to the set of automated bots.

12. The system of claim 8, wherein the intent is identified as a result of the intent having a highest threshold value compared to other possible intents associated with the communications.

13. The system of claim 8, wherein the instructions further cause the system to:
identify a new intent associated with the communications session, wherein the new intent is not associated with any automated bot within the set of automated bots; and
transfer the communications session from the alternative automated bot to a live agent.

14. The system of claim 8, wherein the instructions further cause the system to:
detect a prohibited communication, wherein the prohibited communication is detected according to one or more policies; and
automatically transmit a response message, wherein the response message is automatically transmitted without bot intervention.

15. A non-transitory, computer-readable storage medium storing thereon executable instructions that, as a result of being executed by one or more processors of a computer system, cause the computer system to:
dynamically monitor a communications session in real-time as communications are exchanged between a user and an automated bot, wherein the automated bot is associated with a bot group including a set of automated bots;
identify an intent associated with the communications;
determine that the automated bot is incapable of providing responses corresponding to the intent through the communications session;
train a machine learning algorithm in real-time to dynamically associate different automated bots with identified intents, wherein the machine learning algorithm is trained using a dataset of sample communications sessions, known intents, and automated bot responses corresponding to the known intents;
identify an alternative automated bot capable of providing the responses corresponding to the intent, wherein the alternative automated bot is identified from the set of automated bots through the machine learning algorithm;
automatically transfer the communications session in real-time from the automated bot to the alternative automated bot; and
update the machine learning algorithm according to feedback corresponding to new responses generated by the alternative automated bot for the intent.

16. The non-transitory, computer-readable storage medium of claim 15, wherein the executable instructions further cause the computer system to:
provide contextual information previously obtained through the communications exchanged between the user and the automated bot, wherein the contextual information is provided to prevent the alternative automated bot from submitting a repeated query for the contextual information.

17. The non-transitory, computer-readable storage medium of claim 15, wherein the executable instructions further cause the computer system to:
identify a new intent associated with the communications session, wherein the new intent is not associated with any automated bot within the set of automated bots; and
transmit a fallback message through the communications session.

18. The non-transitory, computer-readable storage medium of claim 15, wherein the executable instructions further cause the computer system to:
automatically detect contextual information exchanged through the communications session; and
store the contextual information, wherein when the contextual information is stored, the contextual information is available to the set of automated bots.

19. The non-transitory, computer-readable storage medium of claim 15, wherein the intent is identified as a result of the intent having a highest threshold value compared to other possible intents associated with the communications.

20. The non-transitory, computer-readable storage medium of claim 15, wherein the executable instructions further cause the computer system to:
identify a new intent associated with the communications session, wherein the new intent is not associated with any automated bot within the set of automated bots; and
transfer the communications session from the alternative automated bot to a live agent.

21. The non-transitory, computer-readable storage medium of claim 15, wherein the executable instructions further cause the computer system to:
detect a prohibited communication, wherein the prohibited communication is detected according to one or more policies; and
automatically transmit a response message, wherein the response message is automatically transmitted without bot intervention.
